(19) United States
(12) Patent Application Publication
(10) Pub. No.: US 2026/0299515 A1
(43) Pub. Date: Oct. 1, 2026

(54) Holographic Projection System

(71) Applicant: Envisics Ltd, Milton Keynes (GB)

(72) Inventor: Jamieson Christmas, Milton Keynes (GB)

(21) Appl. No.: 19/489,047

(22) PCT Filed: Jun. 11, 2024
(86) PCT No.: PCT/EP2024/066100

§ 371 Date: Dec. 1, 2025

(30) Foreign Application Priority Data
Jun. 12, 2023 (GB) 2308743.0

(51) Int. Cl. G03H 1/26; G02B 27/01

(52) U.S. Cl. CPC G03H 1/26; G02B 27/0103; G03H 2001/2605; G03H 2223/18

(57) ABSTRACT

There is provided a hologram engine arranged to receive a plurality of sub-holograms or sub-holograms The hologram engine may be arranged to divide a target picture into a plurality of portions. The hologram engine may be further arranged to calculate a sub-hologram of each of the plurality of portions of the target picture. The hologram engine is further arranged to form a hologram by spatially interlacing the sub-holograms in a random or irregular fashion.

### FIELD

The present disclosure relates to a holographic projection system. More specifically, the present disclosure relates a holographic projection system having a relatively wide field of view and a method of increasing the field of view of a holographic projection system. Yet more specifically, the present disclosure relates to a holographic projection system comprising a wavefront redirector arranged to receive first and second spatially interlaced sub-holograms. The holographic projection system and the wavefront redirector are arranged to increase a field of view of the optical system. Some embodiments relate to a holographic projector, picture generating unit or head-up display.

### BACKGROUND AND INTRODUCTION

Light scattered from an object contains both amplitude and phase information. This amplitude and phase information can be captured on, for example, a photosensitive plate by well-known interference techniques to form a holographic recording, or “hologram”, comprising interference fringes. The hologram may be reconstructed by illumination with suitable light to form a two-dimensional or three-dimensional holographic reconstruction, or replay image, representative of the original object.

Computer-generated holography may numerically simulate the interference process. A computer-generated hologram may be calculated by a technique based on a mathematical transformation such as a Fresnel or Fourier transform. These types of holograms may be referred to as Fresnel/Fourier transform holograms or simply Fresnel/Fourier holograms. A Fourier hologram may be considered a Fourier domain/plane representation of the object or a frequency domain/plane representation of the object. A computer-generated hologram may also be calculated by coherent ray tracing or a point cloud technique, for example.

A computer-generated hologram may be encoded on a spatial light modulator arranged to modulate the amplitude and/or phase of incident light. Light modulation may be achieved using electrically-addressable liquid crystals, optically-addressable liquid crystals or micro-mirrors, for example.

A spatial light modulator typically comprises a plurality of individually-addressable pixels which may also be referred to as cells or elements. The light modulation scheme may be binary, multilevel or continuous. Alternatively, the device may be continuous (i.e. is not comprised of pixels) and light modulation may therefore be continuous across the device. The spatial light modulator may be reflective meaning that modulated light is output in reflection. The spatial light modulator may equally be transmissive meaning that modulated light is output in transmission.

A holographic projector may be provided using the system described herein. Such projectors have found application in head-up displays, “HUD”.

### SUMMARY

Aspects of the present disclosure are defined in the appended independent claims.

There is a need in the field of holographic projection systems for a relatively large field of view for a user/viewing system at a viewing window of the holographic projection system. The field of view refers to the angular extent of the holographic reconstruction (i.e. image) that is viewable at the viewing window. So, the field of view is generally determined by the range of angles (e.g. horizontal and vertical angles) over which a user/viewing system can see the full image. In holographic projection systems comprising a display device, the field of view is usually limited by the diffraction angle of the display device. However, the inventors have provided a holographic projection system according to the present disclosure which breaks this rule. The holographic projection system according to the present disclosure is arranged to provide a field of view greater than the fundamental limit defined by the diffraction angle (of a display device of the holographic projector), for example that is double or even triple the diffraction angle.

The holographic projection system proposed by the inventors provides an unconventional approach to increasing the field of view of the system which does not constrain the design/selection of the display device to primarily consider achieving a desired field of view. In general terms, there is provided a holographic projection system. The holographic projection system comprises a holographic wavefront redirector that is arranged to deflect (or redirect or turn) light that is spatially modulated in accordance with a hologram comprising a plurality of sub-holograms such that light associated with different sub-holograms is deflected by different amounts by the holographic wavefront redirector. In this way, the holographic projection system (in particular, the holographic wavefront redirector and hologram) is arranged to increase (optionally at least double or at least triple) the field of view of the system. In angular terms, the field of view is increased above the diffraction angle of the display device. The angular field of view may be two or three times the diffraction angle. In particular, the inventors have recognised that by applying different turns or deflections to the light of the different sub-holograms, the overall range of angles of light propagating downstream of the holographic wavefront redirector can be increased. In some embodiments, the holographic projection system comprises a display device which may be a pixellated display device such as a spatial light modulator, such as a liquid crystal on silicon spatial light modulator. In some embodiments, the holographic projection system is arranged to increase the field of view of the system so as to exceed a maximum diffraction angle of a display device. Importantly, this increased field of view can be achieved without changing physical attributes of the display device such as pixel size or display device size (e.g. display area of the display device size) and without relying on magnification or demagnification of a holographic wavefront to achieve the increased field of view. This enables the selection/design of the display device to be based on other design considerations (such as cost, practicality, manufacturability and/or suitability for forming a good quality holographic reconstruction) rather than being constrained by the need to provide a large field of view. Importantly, the holographic wavefront redirector is compatible with a relatively small display device. Furthermore, the holographic projection system proposed by the inventors advantageously allows for different fields of view to be achieved with the same display device (or the same field of view to be achieved in a different context) simply by changing or modifying the holographic wavefront redirector. This may enable the holographic projection system to be easily modified to different use scenarios. For example, in the context of head-up displays for vehicles, the holographic projection system may easily modified for use in different vehicle models. As described in more detail below, the windscreen of the vehicle may act as an optical combiner and may have a magnifying or demagnifying effect which may decrease or increase the field of view, respectively. Different models of car may have different windscreens. The holographic projection system may simply be modified so that the holographic wavefront redirector is suitable for achieving a desired field of view irrespective of the particular vehicle model (without changing the display device).

The obvious way to increase the field of view of a system is to decrease a pixel pitch on a display device of the system (the display device being for displaying the hologram). However, as described herein, the inventors have found that this is not an efficient way to achieve a field of view that is large enough to be suitable for head-up displays in vehicles, for example. In more detail, holographic projectors may comprise a pixellated display device (such as a spatial light modulator). There will be a (maximum) diffraction angle associated with the pixellated display device. This (maximum) diffraction angle is determined by the pitch of the pixels of the display device (the pitch being equal to the distance between the respective centres of adjacent pixels of the display device). As the pitch decreases, the (maximum) diffraction angle increases. The (maximum) diffraction angle of the display device is an important factor in determining the field of view of the system. In the absence of any other magnifying or demagnifying optics, the field of view of the system (at the eye-box/viewing window) would be the same as diffraction angle of the display device. However, the inventors have recognised that there is a limit on how far it is practical to reduce the size of the pixels of the display device of a holographic projection system. As the size of the pixels decreases, the cost of the display device increases. Furthermore, there is a limit on the minimum size of pixels of a display device that manufacturers are currently able to provide. The inventors have found that display devices with suitably small pixels are not currently available (at least not that are cost effective and reliable) to achieve a desired field of view solely based on pixel size selection. Furthermore, in a head-up display for a vehicle, light from the holographic projection system may be relayed to the viewing window/eye-box via the windscreen (or windshield) of the vehicle. A windscreen typically has a magnifying effect which acts to decrease the field of view of the system at the viewing window/eye-box relative to the (maximum) diffraction angle. Thus, if the desired field of view were to be achieved by shrinking the pixel pitch, the presence of a windscreen may further decrease the required pixel size (even further beyond what is practical).

There is another problem with reducing the pixel size/pitch, as this results in an increase in the total number of pixels (for a given size of display device). The inventors have found that this results in the total number of pixels being much greater than is necessary for a good quality holographic reconstruction. So, from a holographic reconstruction quality point of view, the “extra” pixels resulting from selecting a display device with smaller (but more) pixels to increase the field of view, are unnecessary. But these extra pixels will result in an increase in the cost of the display device/holographic projector as a whole as well as significantly increasing the computational cost of calculating a larger/higher resolution hologram for the higher resolution display device. In other words, the inventors have found that increasing the field of view simply by selecting a display device with decreased pixel pitch is inefficient and impractical. Of course, the total number of pixels could be reduced by reducing the display size, but the inventors have found that there are other design constraints which mean that the size of the display device cannot easily be reduced (and without affecting adversely affecting the viewing experience).

So, the inventors have found that the obvious approach for increasing the field of view of a system has drawbacks and compromises which place constraints on the selection of the display device of the holographic projector to achieve a desired field of view while compromising, for example, on cost (both real and computational), complexity and efficiency. The unconventional holographic projection system according to the present disclosure provides a means for increasing the field of view of the system without these compromises and, in particular, without being constrained by the selection of a display device used in the holographic projection system.

The inventors have also proposed a hologram engine (for the holographic projection system proposed above). In general terms, the hologram engine proposed by the inventors is arranged to form the (composite) hologram described above. In particular, the hologram engine proposed by the inventors is arranged to divide a target picture into a plurality of portions and calculate a sub-hologram of each of the plurality of portions of the (divided) target picture. The hologram engine is further arranged to spatially interlace the sub-holograms to form the (composite) hologram. Said hologram may then be output to a display device of a holographic projection system and/or said display device may be driven in accordance with the hologram. When illuminated, the hologram may spatially modulate the incident light in accordance with the hologram to form a holographic wavefront. The holographic wavefront may then be processed with an appropriately positioned holographic wavefront redirector (as described above) to increase the field of view of the system and so enables the advantages (also described above).

In addition, the inventors have recognised that it is particularly advantageous for the spatially interlacing of the sub-holograms to be or appear random or irregular. This mean that any patterns in the pixel arrangement of the hologram formed by the hologram engine are irregular. In other words, any periodicity in the pixel arrangement of the hologram is greater than a dimension of the hologram. As used herein, references to patterns or periodicity in the pixel arrangement of the hologram may refer to patterns or periodicity in the pixel arrangement by sub-hologram. In this way, the pixel arrangement may at least appear random by sub-hologram. In some embodiments, this may result in the hologram comprising a sequence (e.g. arrangement or pattern) of discrete portions of the plurality of sub-holograms. The sequence, arrangement or pattern may be randomly ordered by sub-hologram. In such cases, the spatial interlacing may comprise forming the (composite) hologram by piecing together or appending portions of the sub-holograms. The inventors have found that, if the (composite) hologram is formed by piecing together or appending portions of sub-hologram in a regular, repeating or periodic fashion (such that the (composite) hologram comprises portions of sub-holograms in an alternating configuration, then the periodic nature of the (composite) hologram can result in the formation of a bright spot appearing in a holographic reconstruction of the target picture. The bright spot may be referred to as a DC spot. The location of the bright/DC spot may depend on the periodicity (in angular space) of the repeating pattern (at the pixel level) of each sub-hologram. The inventors have found that, if the spatial interlacing is or appears irregular/random (rather than regular/periodic) then the bright/DC spot can be substantially reduced or eliminated. The (composite) hologram may comprise a plurality of discrete portions of the sub-holograms. Random spatial interlacing in this context may mean that the plurality of discrete portions are in a random sequence of sub-holograms, for example such that each discrete portion of the (composite) hologram is formed by a) randomly selecting one of the plurality of the plurality of sub-holograms; b) identifying a portion of the selecting sub-hologram to form the discrete hologram portion; and repeating a) and b) for each of the discrete portions. In other words, the “random” nature of the spatial interlacing refers to the order of portions of the sub-holograms in the sequence. For example, a regular, periodic sequence of three sub-holograms may comprise portions of the sub-holograms in the following sequence: first sub-hologram, second sub-hologram, third sub-hologram, first sub-hologram, second sub-hologram, third sub-hologram, first sub-hologram, second sub-hologram, third sub-hologram and so on. A random sequence may instead appear as portions of the sub-holograms as follows (for example): first sub-hologram, third sub-hologram, second sub-hologram, third sub-hologram, first sub-hologram, first sub-hologram, second sub-hologram, first sub-hologram, third sub-hologram second sub-hologram, third sub-hologram, and so on.

There is provided a holographic projection system. The holographic projection system comprises a hologram engine. The hologram engine may be arranged to divide a target picture. The hologram engine may be arranged to divide the target into a first portion and a second portion. In some embodiments, the hologram engine may be arranged to divide the target into further portions, for example into a third portion. In some embodiments, each of the portions may correspond to different fields of view of the target picture. For example, the first portion may correspond to a left portion (or field of view) of the target picture. The second portion may correspond to a right portion (or field of view) of the target picture. If present, the third portion may correspond a middle portion (or field of view) of the target picture which may be between the first and second portions. The hologram engine may be further arranged to calculate a first sub-hologram of the first portion of the target picture. The hologram engine may be further arranged to calculate a second sub-hologram of the second portion of the target picture. In other words, the hologram engine may, separately, calculate different sub-holograms of different portions of the target picture (which may correspond to different fields of view of the target picture). The hologram engine may be arranged to simply receive a first sub-hologram and second sub-hologram. The hologram engine may be arranged to interlace the first and second sub-holograms. The hologram engine may be arranged to spatially interlace the first and second sub-holograms to form a hologram. The “formed” hologram may be referred to as a composite hologram. The composite hologram comprises the (spatially) interlaced sub-holograms. The hologram engine may be arranged to form the hologram by piecing together or appending respective portions of the first and second sub-holograms in a substantially alternating configuration. In some embodiments, the spatial interlacing may comprise sequentially piecing together or appending respective portions of the first and second sub-holograms. In other embodiments, the spatial interlacing may comprise randomly selecting a portion of the first or second sub-hologram. In other words, the spatial interlacing may be random. If further sub-holograms are present (e.g. a third sub-hologram), the hologram engine may include those further sub-holograms in the spatial interlacing. Thus, in such embodiments, the (composite) hologram may comprise first, second and third sub-holograms.

The holographic projection system further comprises a wavefront redirector which is also referred to herein as a holographic wavefront redirector. The holographic wavefront redirector is positioned at or substantially adjacent to the hologram or a relayed copy of the hologram. The hologram may be displayed on a display device (which is a feature of the holographic projection system, in some embodiments). The holographic wavefront redirector being positioned substantially adjacent to the hologram may mean that the holographic wavefront redirector is positioned at or adjacent the display device. In some embodiments, the holographic projection system comprises an optical relay (such as a magnifying telescope). The optical relay may be arranged to form the relayed hologram. This will be described in more detail below. In such embodiments, the holographic wavefront redirector may be positioned adjacent to the relayed hologram. The holographic wavefront redirector comprises a plurality of first redirection zones optically coupled to the first sub-hologram. The holographic wavefront redirector comprises a plurality of second redirection zones optically coupled to the second sub-hologram. Herein, the first and second redirection zones being optically coupled to the first and second sub-holograms may mean that each first redirection zone is substantially aligned with or corresponds to a portion of the first sub-hologram in the hologram or relayed hologram and that each second redirection zone is substantially aligned with or corresponds to a portion of the second sub-hologram in the hologram or relayed hologram. As such, light that is spatially modulated in accordance with the (respective portion of the) first sub-hologram may be received by each first redirection zone and light that is spatially modulated in accordance with the (respective portion of the) second sub-hologram may be received by each second redirection zone. The holographic wavefront redirector is arranged to increase the field of view of the system. For example, the holographic wavefront redirector is arranged to receive and process a holographic wavefront formed by the hologram (at a position adjacent to the hologram or a relayed hologram) to increase the field of view of the system.

In some embodiments, each of the first redirection zones is arranged to deflect received light at a first deflection angle with respect to a propagation axis of the system. In some embodiments, each of the second redirection zones is arranged to deflect received light at a second deflection angle (that is different to the first deflection angle) with respect to the propagation axis such that the holographic wavefront redirector is arranged to increase a field of view of the system. As used herein, the (first or second) deflection angle refers to an amount the light is deflected/turned/bent/redirected when incident on a respective redirection zone. The angle may be measured with respect to a propagation axis of the holographic projection system. The deflection angle may be substantially zero. In other words, one of the first or second redirection zones may be arranged to apply substantially zero (or substantially no) deflection to light incident thereon. However, as the first and second deflection angles are different to one another, the other of the first and second deflection angles will be non-zero so as to achieve an expansion of the field of view of the system. In some embodiments, the first and second deflection angles are both non-zero. Advantageously, the first and second deflection angle may be opposite in direction and may also be equal in magnitude. The holographic wavefront redirector may be arranged to increase a field of view of the system to be greater than a maximum diffraction angle of a display device of the holographic projection system. In some embodiments, a magnitude of the first deflection angle is substantially equal to half the (maximum) diffraction angle of the display device, and optionally wherein a magnitude of the second deflection angle is substantially equal to half the (maximum) diffraction angle of the display device.

In more detail, at the point of being received by the holographic wavefront redirector (e.g. adjacent the display device or adjacent a relayed hologram), a holographic wavefront formed by the hologram may be diverging over a continuous range of angles. The angle of divergence of the holographic wavefront may be equal to a (maximum) diffraction angle of a display device displaying the hologram. Over that (continuous) range of angles, the holographic wavefront comprises light that has been spatially modulated in accordance with both the first and second sub-holograms (which are spatially interlaced). Thus, the hologram may be arranged such that if a holographic reconstruction of the hologram were formed in the absence of the holographic wavefront re-director, a reconstruction of the first and second potions of the (target) picture would appear to at least partially overlap. The holographic wavefront redirector deflects the light of the different sub-holograms differently so as to increase the field of view. Thus, downstream of the holographic wavefront redirector, the holographic wavefront may diverge over an increased continuous range of angles. In other words, downstream of the holographic wavefront redirector, the holographic wavefront may diverge over a range of angle that is greater than a (maximum) diffraction angle of the display device. A first sub-portion of the (expanded) continuous range of angles of the holographic wavefront may comprise only light of the first sub-hologram and a second sub-portion of the (expanded) range of angles of the holographic wavefront may comprise only light of the second sub-hologram as a result of the deflection by the holographic wavefront redirector. This may result in a holographic reconstruction being formed in which an overlap between holographic reconstructions of the first and second portions of the picture is reduced, for example such that each portion of the picture is reconstructed substantially adjacent to one another. In other words, the hologram may be arranged such that different portions of the target picture corresponds to different fields of view. In the absence of the holographic wavefront redirector, the holographic reconstruction might comprise those different fields of view superimposed on one another. However, by applying a deflection/turn, the different fields of view of the picture may appear adjacent one another in the reconstruction.

The target picture can be divided into any number of portions. The holographic projector may comprise a sub-hologram for each portion and the holographic wavefront redirector may comprises a sub-set of redirection zones for each portion of the target picture that are arranged to deflect light at a different respective angle for each sub-set. It should be appreciated that the maximum increase in the field of view of the system achieved by the holographic wavefront re-director may be equal to a multiple of the number of portions that the target picture is divided into. For example, if the target picture is divided into two, the field of view may be doubled with each portion contributing to half of the field of view. Similarly, if the target picture is divided into three, the field of view of the system may be tripled by the holographic wavefront redirector.

The holographic projection system according to the present disclosure was counter-intuitive. In particular, it was counter-intuitive to develop the present holographic projection system further comprising a waveguide arranged to replicate the hologram to form an extended modulator comprising a plurality of replicas of the hologram. This is because the hologram comprises sub-holograms encoding different portions of the target picture. If those sub-holograms were adjoined together (e.g. such that one relatively (first) sub-hologram of a left portion of a target picture were adjoined to another relatively large (second) sub-hologram of a right portion of a target picture) then there would be a risk that a user/viewing system at the viewing window may perceive dark bands. This, there was a prejudice against displaying different holograms (of different pictures or portions of pictures) simultaneously on the display device. However, the inventors have surprisingly found that (spatially) interlacing the first and second sub-holograms (as described above) substantially reduces or eliminates the risk of dark bands. The inventors have found that it is particularly advantageous for the discrete areas of the modulator emitting different angular content to be small enough that the naked eye is not able to distinguish between different these discrete areas. The inventors have recognised that, in such cases, dark bands should be effectively negligible/non-existent. Thus, the discrete areas may preferably have an angular range or angular extent in a first direction of 1/20 of a degree or a less, optionally less than 1/40 of a degree or less, optionally 1/60 of a degree or less. For example, the extended modulator may be roughly 1 metre away from the eye-box. If the width of each discrete area on the extended modulator in the first direction is less than about 1 millimetre or less, optionally 0.8 millimetre or less, optionally 0.5 millimetre or less, then the angular range or extent of the width of adjacent discrete areas in the first direction may appear so small that the naked eye of a user in the eye-box may not be able to distinguish between the different discrete areas.

In some embodiments, each first and second redirection zone may be arranged to have an angular extent, in a first direction, of 1/20 of a degree or less, optionally less than 1/40 of a degree or less, optionally 1/60 of a degree or less when viewed from an eye-box of the holographic projection system. In some embodiments, each first and second redirection zone has a width in the first direction of 1 millimetre or less, optionally 0.8 millimetre or less, optionally 0.5 millimetre or less.

Similarly, each portion of the first and second sub-holograms of the hologram (which may be displayed on a display device) or relayed hologram may be arranged to have an angular extent, in the first direction, of 1/20 of a degree or a less, optionally less than 1/40 of a degree or less, optionally 1/60 of a degree or less when viewed from an eye-box of the holographic projection system. In some embodiments, each portion of the first and second sub-holograms of the hologram may have a corresponding width in the first direction (in other words, each portion of the first and second sub-holograms may have a width of 1 millimetre or less, optionally 0.8 millimetre or less, optionally 0.5 millimetre or less). For example, each sub-hologram may be divided or separated into strips having a width of 1 millimetre or less, optionally 0.8 millimetre or less, optionally 0.5 millimetre or less. The first and second redirection zones/first and second holograms of the hologram may have a larger extent in a second direction (e.g. a direction perpendicular to the first direction) than in the first direction.

In some embodiments, the holographic wavefront redirector is arranged to increase the field of view of the system by at least 1.5 times, optionally to at least double the field of view of the system, optionally at least triple the field of view of the system.

In some embodiments, the hologram engine is arranged to receive the target picture. The hologram engine may receive the target picture prior to dividing the target picture.

In some embodiments, the hologram engine is further arranged to provide the first sub-hologram as a plurality of first portions or strips. In some embodiments, the hologram engine is further arranged to separate/split/divide the first sub-hologram into a plurality of first sub-areas or strips. The hologram engine may be further arranged to provide the second sub-hologram as a plurality of second portions or strips. This may comprise separating/splitting/dividing the second sub-hologram into the plurality of second portions or strips.

The hologram engine is further arranged to spatially interlace the first and second sub-holograms by spatially interlacing the plurality of first sub-areas or strips with the plurality of second sub-areas or strips. The strips may be elongated in the second direction described above. Each first and second strip may have a width of 1 millimeter or less in the first direction, optionally 0.8 millimeter or less, optionally 0.5 millimeter or less.

In some embodiments, each of the first redirection zones (of the holographic wavefront redirector) is optically coupled to a respective first strip of the first sub-hologram and each of the second redirection zones is optically coupled to a respective second strip of the second sub-hologram. In embodiments in which the sub-holograms are separated into elongated strips, the redirection zones of the holographic wavefront redirector may similarly have the form of elongated strips (elongated in the second direction).

In some embodiments, the holographic projection system comprises a display device. In such embodiments, the hologram engine may be arranged to output the hologram to the display device. In the hologram engine may be arranged to drive the display device to display the hologram.

In some embodiments, the holographic projector is arranged to spatially modulate light in accordance with the hologram to form a holographic wavefront that forms a holographic reconstruction of the picture that is viewable from an eye-box. The holographic wavefront redirector may be arranged to receive the holographic wavefront, the holographic wavefront comprising a plurality of first portions that are spatially modulated in accordance with the first sub-hologram and a plurality of second portions that are spatially modulated in accordance with the second sub-hologram; and wherein the holographic wavefront redirector is arranged such that each first redirection zone receives a first portion of the holographic wavefront and each second redirection zone receives a second portion of the holographic wavefront. The holographic wavefront redirector may be arranged such that spatially modulated light in accordance with the first sub-hologram forms a first continuous range of angles of a field of view of the holographic reconstruction viewable at the eye-box, and such that spatially modulated light in accordance with the second sub-hologram forms a second continuous range of angles of the field of view of the holographic reconstruction viewable at the eye-box. The first continuous range of angles of the field of view may correspond to a left portion of the field of view. The second continuous range of angle of the field of view may correspond to a right portion of the field of view.

In some embodiments, the holographic wavefront redirector comprise an array of prisms. The array of prisms may comprise a first subset of prisms and a second subset of prisms. Each prism may form a respective (first or second) redirection zone of the holographic wavefront redirector. Prisms of the first subset of prisms may be spatially interlaced with prisms of the second subset of prims in the array of prisms. The holographic wavefront redirector may be arranged such that each first redirection zone is formed by a prism of the first subset of prisms, and wherein each second redirection zone is formed by a prism of the second subset of prisms. Each prism of the first subset of prisms may be arranged to deflect received light at the first deflection angle with respect to the propagation axis of the holographic projection system. Each prism of the second subset of prisms may be arranged to deflect received light at the second deflection angle that is different the first.

Each prism may comprise an input surface. The input surface may be elongated in the second direction and may have a width in the first direction as described above (e.g. 1 millimetre or less, optionally 0.8 millimetre or less, optionally 0.5 millimetre or less). Each input surface may be arranged to receive a portion of the holographic wavefront. Each prism may further comprise an output surface. Each output surface may be substantially opposite to a respective input surface. Each output surface may be arranged to output a respective portion of the holographic wavefront. In some embodiments, the holographic wavefront redirector is arranged such that a first angle between the input surface and the output surface of a first subset of the prisms is different to a second angle between the input surface and output surface of a second subset of the prisms. The first and second angles between the input surface and the output surface may define the deflection angle such that different sub-sets of prisms are arranged to deflect received light by a different amount.

In some embodiments, each prism of the holographic wavefront material may be formed of a substantially transparent material. The substantially transparent material may have a refractive index greater than one. Thus, the prisms may be arranged to deflect light as a result of refraction of light at the air/input surface and output surface/air boundaries of the prisms. The different angles between the input and output surfaces of the first and second sub-sets of the prisms results in different amounts of deflection by refraction.

In some (other) embodiments, the holographic wavefront redirector is a diffractive optical element. In some embodiments, the diffractive optical element is arranged such that the redirection zones of the holographic wavefront redirector are defined in a diffraction pattern of the diffractive optical element. In some embodiments, the diffractive optical element is arranged such that light received at a first subset of redirection zones is principally re-directed into a non-zero diffractive order defined by a first diffraction angle. In some embodiments, the diffractive optical element is further arranged such that light received at a second subset of redirection zones is principally redirected into a non-zero diffractive order defined by a second diffraction angle that is different the first diffraction angle. In some embodiments, the first diffraction angle is equal and opposite to the second diffraction angle. In such embodiments, the first diffraction angle may be equivalent to the first deflection angle and the second diffraction angle may be equivalent to the second deflection angle.

In some embodiments the holographic wavefront redirector may comprise an array of diffraction gratings (such as blazed gratings). As the skilled reader will be familiar, each diffraction grating of the array of diffraction gratings may be arranged to redirect or steer incident light. The first redirection zones of the holographic wavefront redirector may be formed or defined by a first sub-set of the array of diffraction gratings. Each diffraction grating in the first sub-set of the array of diffraction gratings may be arranged to redirect or steer incident light at the first deflection angle. The second redirection zones of the holographic wavefront redirector may be formed or defined by a second sub-set of the array of diffraction gratings. Each diffraction grating in the second sub-set of the array of diffraction gratings may be arranged to redirect or steer incident light at the second deflection angle. As such, a pitch or spacing (between slits of a respective grating) may have a first value for each diffraction grating of the first sub-set and a second (different) value for each diffraction grating of the second sub-set.

In some embodiments, the holographic projector further comprises an optical relay. The optical relay may be between the hologram (e.g. the display device on which the hologram is displayed) and the holographic wavefront redirector. The optical relay may comprise two lenses (a first lens and a second lens). The first and second lenses may be arranged in cooperation to receive a holographic wavefront and form a (the) relayed hologram. The relayed hologram may be an image of the hologram displayed on a display device. The relayed hologram may be formed at a first plane.

In some embodiments, the holographic wavefront redirector is positioned at the first plane.

In some embodiments, the holographic wavefront redirector may instead be positioned at or adjacent to the hologram (i.e. on the display device). For example, the holographic wavefront redirector may be in contact with, attached to or otherwise fixed to the display device. In embodiments in which the holographic wavefront redirector comprises an array of diffraction gratings (such as blazed gratings), the pitch or spacing (between slits of each grating) may be less than a pixel pitch of the display device. In other words, the density of slits of each diffraction grating (in at least the first direction) may be greater than the pixel density in the first direction. In this way, holographic wavefront redirector may advantageously be suitable for providing a deflection or turn angle which exceeds the available range of diffraction angles of the display device (which is determined by pixel pitch, as above). Thus, the holographic wavefront redirector may expand the field of the view of the system beyond the diffraction angle of the display device.

A holographic wavefront (formed by spatially modulating in accordance with the hologram) may be formed by diffraction of light on a display device displaying the hologram. As the skilled reader will recognise, such a holographic wavefront may comprise a plurality of non-zero diffraction orders. One of the (non-zero) diffraction orders may be referred to as a principal diffraction order. This may be the (non-zero) diffraction order of highest intensity in the holographic wavefront. The holographic reconstruction formed by the principal (non-zero) diffraction order may be the holographic reconstruction of interest, that is intended to be viewed by a user in an eye-box/viewing window of the holographic projector system. In some embodiments, the optical relay comprises a filter disposed at an intermediate plane between the first lens and the second lens. In some embodiments, the filter may be arranged to receive and filter non-principal (e.g. above 1st order) diffraction orders of the holographic wavefront. In other words, the filter may be arranged to prevent propagation of the non-principal diffraction orders along a propagation axis of the projector. This may remove the other (non-principal) orders and prevent those non-principal orders from forming (non-principal) holographic reconstructions viewable from the eye-box. This may improve the viewing experience. If filtering of the non-principal diffraction orders is desired, the inventors have found that it may be advantageous to do this before the holographic wavefront is received by holographic wavefront redirector. This is because, once the holographic wavefront redirector has processed the holographic wavefront, it may become difficult to filter out the non-principal diffraction orders because these may have been deflected by the redirector to become mixed in with the principal diffraction orders. So, it may be advantageous for the holographic wavefront redirector to be arranged to receive a relayed hologram (i.e. positioned at the first plane of the optical relay) in embodiments comprising an optical relay and filter. In some embodiments, the filter may be arranged to remove so-called DC spot light.

In some embodiments, the holographic projector system may further comprise a waveguide. The waveguide may be arranged to receive the holographic wavefront. The waveguide may be arranged to waveguide the received holographic wavefront between a pair of reflective surfaces thereof, wherein one surface of the pair of reflective surfaces is partially transmissive such that a plurality of replicas of the holographic wavefront are emitted therefrom.

There may be provided a holographic projection system comprising a hologram engine. The hologram engine is arranged to divide a target picture into at least a first portion and a second portion. The hologram engine is further arranged to calculate a first sub-hologram of the first portion of the target picture and a second sub-hologram of the second portion of the target picture.

In some embodiments, the hologram engine is further arranged to drive a display device to display the first and second sub-holograms. The hologram engine may be arranged to drive the display device such that the first sub-hologram is displayed on a plurality of first sub-areas or first zones of the display device. The hologram engine may be arranged to drive the display device such that the second sub-hologram is displayed on a plurality of second sub-areas or second zones of the display device. In some embodiments, each first sub-area or zone of the display device may comprise a plurality of pixels. In some embodiments, each second sub-area or zone of the display device may comprise a plurality of pixels. The (first and second) sub-areas/zones of display device may not overlap with one another. In other words, the pixels forming each sub-area or zone may be different. In some embodiments, the first and second sub-areas/zones may be arranged in an alternating configuration. In other words, the first and second sub-areas/zones may be interlaced. Thus, when the (first and second) sub-holograms are displayed on the respective (first and second) sub-areas/zones of the display device, the first and second sub-holograms may be interlaced. In some embodiments, the first and second sub-holograms may be spatially interlaced. In some embodiments, the first and second sub-holograms may be temporally interlaced. In some embodiments, each sub-area/zone may have the form of an (elongated) strip. The width of each strip (in a first direction, as described previously) may be 1 millimeter or less, optionally 0.5 millimeter or less.

The system further comprises a holographic wavefront redirector positioned at or substantially adjacent to the hologram or a relayed hologram. The holographic wavefront redirector comprises a plurality of first redirection zones. Each first redirection zone may be optically coupled to a first sub-area/zone of the display device. Thus, when the first sub-hologram is displayed on the display device, each first redirection zone may be optically coupled to the first sub-hologram. The holographic wavefront redirector further comprises a plurality of second redirection zones. Each second redirection zone may be optically coupled to a second sub-area/zone of the display device. Thus, when the second sub-hologram is displayed on the display device, each second redirection zone may be optically coupled to the second sub-hologram.

In some embodiments, each of the first redirection zones is arranged to deflect received light by a first deflection angle with respect to a propagation axis of the system. In some embodiments, each of the second redirection zones is arranged to deflect received light by a second deflection angle with respect to the propagation axis.

There is provided a hologram engine for a holographic projection system arranged to spatially modulate light in accordance with a hologram of a target picture (such as the holographic projection system of the first aspect). The hologram engine is arranged to divide a target picture into at least a first portion and a second portion. The hologram engine is further arranged to calculate a first sub-hologram of the first portion of the target picture. The hologram engine is further arranged to calculate a second sub-hologram of the second portion of the target picture. The hologram engine is further arranged to spatially interlace the first and second sub-holograms to form a/the hologram. The hologram engine may be arranged to output the hologram to a display device of the holographic projection system and/or may be arranged to drive the display device to display the (output) hologram.

In some embodiments, the hologram engine is further arranged to provide the first sub-hologram as a plurality of first portions or strips. This may comprise separating the first sub-hologram into the plurality of first portions or strips. The hologram engine may be further arranged to provide the second sub-hologram as a plurality of second portions or strips. This may comprise separating the first sub-hologram into the plurality of portions or strips. The hologram engine may be arranged to spatially interlace the first and second sub-holograms by spatially interlacing the plurality of first portions or strips with the plurality of second portions or strips.

In some embodiments, each first and second portion or strip (of the respective first or second sub-hologram) has a width of 1 millimeter or less, optionally 0.8 millimeter or less, optionally 0.5 millimeter or less.

There is provided a holographic wavefront redirector for a holographic projection system for spatially modulating light in accordance with a hologram to form a holographic wavefront, the hologram comprising a first sub-hologram of a first portion of a target picture and a second sub-hologram of a second portion of the target picture, the first and second sub-holograms being spatially interlaced (wherein the holographic projection system may be in accordance with the first aspect, and may additionally comprise the hologram engine in accordance with the second aspect). The holographic wavefront redirector comprises a plurality of first redirection zones for optically coupling to the first sub-hologram (of the holographic projection system). The holographic wavefront redirector further comprises a plurality of second redirection zones for optically coupling to the second sub-hologram. Each of the first redirection zones is arranged to deflect received light at a first deflection angle with respect to a propagation axis of the system. Each of the second redirection zones is arranged to deflect received light at a second deflection angle with respect to the propagation axis such that the holographic wavefront redirector is arranged to increase a field of view of a holographic wavefront formed by the hologram.

In some embodiments, each first and second redirection zone has a width of 1 millimeter or less, optionally 0.8 millimeter or less, optionally 0.5 millimeter or less.

There is provided a method of increasing the field of view of a holographic projection system. The method comprises the step of dividing a target picture into at least a first portion and a second portion. The method further comprises the step of calculating a first sub-hologram of the first portion of the target picture. The method further comprises the step of calculating a second sub-hologram of the second portion of the target picture. The method further comprises forming a hologram by spatially interlacing the first and second sub-holograms. The method further comprises receiving light at a plurality of first redirection zones of a holographic wavefront redirector. The first redirection zones is optically coupled to the first sub-hologram. The holographic wavefront redirector is positioned at or substantially adjacent to the hologram or a relayed hologram. The method further comprises receiving light at a plurality of second redirection zones of the holographic wavefront redirector. The or each second redirection zone is optically coupled to the second sub-hologram.

In some embodiments, each of the first redirection zones is arranged to deflect received light at a first deflection angle with respect to a propagation axis of the system. In some embodiments, each of the second redirection zones is arranged to deflect received light at a second deflection angle with respect to the propagation axis. In embodiments, the holographic wavefront redirector is arranged to increase a field of view of the system. In some embodiments, the method further comprises separating the first sub-hologram into a plurality of first portions or strips. In some embodiments, the method further comprises separating the second sub-hologram into a plurality of second portions or strips. In some embodiments, spatially interlacing the first and second sub-holograms comprises spatially interlacing the plurality of first portions or strips with the plurality of second portions or strips.

In some embodiments, each first and second strip has a width of 1 millimeter or less, optionally 0.8 millimeter or less, optionally 0.5 millimeter or less.

There is provided a method of calculating a hologram. The method comprises dividing a target picture into at least a first portion and a second portion. The method further comprises calculating a first sub-hologram of the first portion of the target picture. The method further comprises calculating a second sub-hologram of the second portion of the target picture. The method further comprises forming a hologram by spatially interlacing the first and second sub-holograms.

In some embodiments, the method further comprises separating the first sub-hologram into a plurality of first portions or strips. In some embodiments, the method further comprises separating the second sub-hologram into a plurality of second portions or strips. In some embodiments, spatially interlacing the first and second sub-holograms comprises spatially interlacing the plurality of first portions or strips with the plurality of second portions or strips.

In some embodiments, each first and second strip has a width of 1 millimeter or less, optionally 0.8 millimeter or less, optionally 0.5 millimeter or less.

There is provided a method of processing a holographic wavefront formed by spatially modulating light in accordance with a hologram, the hologram comprising a first sub-hologram of a first portion of a target picture and a second sub-hologram of a second portion of the target picture, the first and second sub-holograms being spatially interlaced. The method comprises receiving light at a plurality of first redirection zones of a holographic wavefront redirector, the first redirection zones being optically coupled to (or for optically coupling to) the first sub-hologram. In some embodiments, the holographic wavefront redirector being positioned at or substantially adjacent to the hologram or a relayed hologram. The method further comprises receiving light at a plurality of second redirection zones of the holographic wavefront redirector. The second redirection zones being optically coupled to (or for optically coupling to) the second sub-hologram. Each of the first redirection zones is arranged to deflect received light at a first deflection angle with respect to a propagation axis of the system. Each of the second redirection zones is arranged to deflect received light at a second deflection angle with respect to the propagation axis such that the holographic wavefront redirector is arranged to increase a field of view of the system.

In some embodiments, each first and second redirection zone has a width of 1 millimeter or less, optionally 0.8 millimeter or less, optionally 0.5 millimeter or less.

There is provided a hologram engine. The hologram engine is arranged to receive a plurality of sub-holograms (e.g. for display on different parts of a common display plane or field of view). For example, the hologram engine may be arranged to divide a target picture into a plurality of portions. The hologram engine may be further arranged to calculate a sub-hologram of each of the plurality of portions of the (divided) target picture to order to form the plurality of sub-holograms. The hologram engine is further arranged to form a hologram by spatially interlacing the plurality of sub-holograms in a random or irregular manner or fashion.

The hologram formed by the hologram engine may be referred to as a “composite” hologram. In some embodiments, random or irregular spatial interlacing may result in the (composite) hologram comprising a sequence of discrete portions of the sub-holograms. The sequence may be randomly ordered by or based on the sub-hologram. For example, the hologram engine may be arranged to spatially interlace the composite hologram by repeatedly randomly selecting a sub-hologram for each discrete portion of the (composite) hologram. As explained above, the inventors have found, through simulation and experimentation, that randomizing the spatial interlacing of the sub-holograms is advantageous for forming a (composite) hologram which reduces or eliminates the risk of the formation of a bright/DC spot in a holographic reconstruction. The random or irregular spatial interlacing may result in any patterns in the pixel arrangement of the hologram being irregular (according to sub-hologram). The random or irregular spatial interlacing may result in any periodicity in the pixel arrangement of the hologram (according to sub-hologram) being greater than a dimension of the hologram. Again, this may result in the reduction or elimination of a bright/DC spot in the holographic reconstruction.

In some embodiments, the hologram engine is arranged such that the spatial interlacing comprises, for each discrete portion: randomly selecting one of the plurality of sub-holograms; and identifying a portion of the selected sub-hologram to form the discrete hologram portion.

In some embodiments, the hologram engine is arranged to divide the target picture into at least a first portion and a second portion. In some embodiments, the hologram engine is arranged to calculate at least a first sub-hologram of the first portion of the target picture and a second sub-hologram of the second portion of the target picture. In some embodiments, the first portion of the target picture is a left field of view. In some embodiments, the second portion of the target picture is a right field of view. In such embodiments, the sequence of the discrete portions of the (composite) hologram comprises discrete portions of the first and second sub-holograms arranged in a random order.

In some embodiments, the hologram engine is further arranged to divide the target picture into a third portion and calculate a third sub-hologram of the third portion of the target picture. The third portion of the target picture may be a middle field of view (between the left and right field of view). In such embodiments, the sequence may comprise discrete portions of the first, second and third sub-holograms arranged in a random order.

In some embodiments, the (composite) hologram may be a first hologram comprising a first sequence of discrete portions. The hologram engine may be further arranged to form a second (composite) hologram comprising a second sequence of discrete portions of sub-holograms that is randomly ordered differently to the first sequence (of the first hologram).

In some embodiments, the second (composite) hologram may be of the same target picture. In other words, hologram the second (composite) holograms may effectively be a re-ordering of the first (composite) hologram. In such embodiments, the hologram engine may be arranged to output first and second (composite) holograms in order.

In some embodiments, the second hologram may be formed based on a second target picture. In other words, in such embodiments, the hologram engine may be arranged to form a sequence of (composite) holograms of different target pictures. In such embodiments, the hologram engine may be arranged such that the random spatial interlacing of sub-holograms is different for the different target pictures.

In some embodiments, the hologram engine is arranged to divide the second target picture into a plurality of portions. The hologram engine may be further arranged to calculate a sub-hologram of each of the plurality of portions of the (divided) second target picture. The hologram engine may be further arranged to form the (composite) second hologram by randomly spatially interlacing the (plurality of) sub-holograms of the second target picture such that the (composite) second hologram comprises a second sequence of second discrete portions of the sub-holograms randomly ordered by/based on the sub-hologram of the portions of second target picture.

In some embodiments, the second (composite) hologram may comprise a different number of sub-holograms to the first (composite) hologram. For example, to form the first (composite) hologram, the hologram engine may divide a target picture into three portions, calculate three respective sub-holograms and randomly spatial interlace the three sub-holograms. To form the second (composite) hologram, the hologram engine may divide a target picture into two portions, calculate two respective sub-holograms and randomly spatially interlace the two sub-holograms. In such cases, the field of view of a holographic reconstruction of the first (composite) hologram may be greater than the field of view of a holographic reconstruction second (composite) hologram, when displayed in combination with an appropriately arranged holographic wavefront redirector.

There is provided a holographic projection system. The holographic projection system comprises a hologram engine, for example a hologram engine as defined in the ninth aspect. The holographic projection system further comprises a wavefront redirector. The wavefront redirector may be positioned at or substantially adjacent to the (composite) hologram or relayed (composite) hologram output by the hologram engine.

The holographic wavefront redirector may comprise a plurality of redirection zones. The holographic wavefront redirector may be arranged such that a different subset of the redirection zones is optically coupled to each sub-hologram of the (composite) hologram. For example, a first subset of the plurality of redirection zones may be optically coupled to a first sub-hologram of the (composite) hologram. A second subset of the plurality of redirection zones may be optically coupled to a second sub-hologram of the (composite) hologram. A third subset of the plurality of redirection zones may be optically coupled to a third sub-hologram of the (composite) hologram, if the (composite) hologram comprises three sub-holograms. Each subset of redirection zones may comprise a plurality of redirection zones (e.g. more than two, more the three, more than four, more than five redirection zones). There may be as many of subsets of redirection zones as there are sub-holograms forming the (composite) hologram. Each subset of redirection zones may comprise as many individual zones as there are discrete portions of the respective sub-hologram in the sequence of discrete portions forming the (composite) hologram. In other words, the redirection zones of the different subsets may be arranged in correspondence with the sequence of discrete portions of the hologram formed by the hologram engine. This may be such that a sequence of redirection zones of the respective subsets corresponds to the sequence of the portions of sub-holograms of the (composite) hologram.

In some embodiments, each subset of redirection zones is arranged to deflect received light at a different deflection angle with respect to a propagation axis to increase a field of view of the system (as described in more detail in relation to previous aspects). In some embodiments, the redirection zones of the different subsets are arranged in correspondence with the pixel arrangement of the hologram such that pixels of each sub-hologram experience the same deflection angle. In some embodiments, the holographic wavefront redirector comprises a first subset of (first) redirection zones optically coupled to a first sub-hologram of the (composite) hologram and a second subset of (second) redirection zones optically coupled to a second sub-hologram of the (composite) hologram. In some embodiments, the holographic wavefront redirector may comprise a third subset of (third) redirection zones optically coupled to a third sub-hologram of the (composite) hologram. Each (first) redirection zone of the first subset may be arranged to deflect received light at a first deflection angle with respect to a propagation axis of the system. Each (second) redirection of the second subset may be arranged to deflect received light at a second deflection angle with respect to the propagation axis (that is different to the first deflection angle) such that the holographic wavefront redirector is arranged to increase a field of view of the system. In some embodiments, each (third) redirection zone of the third subset is arranged to deflect received light at a third deflection angle with respect to a propagation axis of the system (that is different to the first or second deflection angle).

In some embodiments, the holographic wavefront redirector is dynamic/active. This may be such that the plurality of redirection zones of the holographic wavefront redirector are reconfigurable in correspondence with the (composite) hologram formed by the hologram engine. In some embodiments, each of the redirection zones are reconfigurable to deflect received light at one of a plurality of discrete deflection angles. The holographic wavefront redirector may be arranged such that there are as many discrete deflection angles as a maximum number of sub-holograms that hologram engine is arranged to form a composite hologram from. For example, if the maximum number of sub-holograms is three, then the plurality of discrete deflection angles may comprise a first, second and third deflection angle. Each of the first, second and third deflection angles may be different to one another. For example, the holographic projection system may be arranged to drive the holographic wavefront redirector such that the redirection zones are driven in correspondence with the sequence of discrete portions forming the composite hologram (which may be output by the hologram engine). For example, the holographic projection system may be arranged to drive (a first subset of) redirection zones of the holographic wavefront redirector that are optically coupled to (portions of) the first sub-hologram to be configured to deflect received light at a first deflection angle. The holographic projection system may be further arranged to drive (a second subset of) the redirection zones that are optically coupled to (portions of) the second sub-hologram to be configured to deflect received light at a second deflection angle. The hologram projection system may be further arranged to drive (a third subset of) the redirection zones that are optically coupled to (portions of) the third sub-hologram to be configured to deflect received light at a third deflection angle.

As described above, the order of the first and second sequence of the first and second holograms may be different. Alternatively or additionally, the number of sub-holograms comprised in the first hologram may different to the number of sub-holograms comprised in the second hologram. The provision of an active or dynamic holographic wavefront redirector may advantageously allow the holographic wavefront redirector to be reconfigured to track/in correspondence with the changes in a sequence of sub-holograms of the hologram output by the hologram engine.

In some embodiments, the system is arranged such that holographic wavefront redirector is drivable between a first configuration in which the redirection zones are arranged in correspondence with a first sequence of discrete portions of a first (composite) hologram formed by the hologram engine and a second configuration in which the redirection zones are arranged in correspondence with a second sequence of discrete portions of a second (composite) hologram.

There is provided a (composite) hologram of a target picture. The hologram comprises a plurality of sub-holograms. Each sub-hologram is a sub-hologram of a portion of the target picture. The hologram is arranged such that the plurality of sub-holograms are randomly or irregularly spatially interlaced. This may be such that the (composite) hologram comprises a sequence of discrete portions of the sub-holograms randomly ordered by/based on the sub-hologram. The spatial interlacing may be such that any patterns in the pixel arrangement of the hologram are irregular and/or any periodicity in the pixel arrangement of the hologram is greater than a dimension of the hologram.

There is provided a wavefront redirector (e.g. holographic wavefront redirector) for a holographic projection system for spatially modulating light in accordance with a composite hologram to form a holographic wavefront. The hologram comprises a plurality of sub-holograms of a respective plurality of portions of a target picture. The plurality of sub-holograms are randomly or irregularly spatially interlaced. This may be such that the (composite) hologram comprises a sequence of discrete portions of the sub-holograms randomly ordered by/based on the sub-hologram. The spatial interlacing being irregular or random may mean that any patterns in the pixel arrangement of the hologram are irregular and/or any periodicity in the pixel arrangement of the hologram is greater than a dimension of the hologram. The holographic wavefront redirector comprises a plurality of redirection zones comprising a plurality of subsets of redirection zones, each subset being optically coupled to a respective sub-hologram. The redirection zones of the different subsets may be arranged in correspondence with the sequence of discrete portions of the hologram formed by the hologram engine. The redirection zones of the different subsets may be arranged in correspondence with the pixel arrangement of the hologram such that pixels of each sub-hologram experience the same deflection angle.

There is provided a method of calculating a hologram. The method comprises dividing a target picture into a plurality of portions. The method further comprises calculating a sub-hologram of each of the plurality of portions of the (divided) target picture. The method further comprises forming a (composite) hologram by randomly spatially interlacing the (plurality of) sub-holograms. This may be such that the (composite) hologram comprises a sequence of discrete portions of the sub-holograms randomly ordered by/based on the sub-hologram. The spatial interlacing may be such that the redirection zones of the different subsets are arranged in correspondence with the pixel arrangement of the hologram such that pixels of each sub-hologram experience the same deflection angle.

In some embodiments, the step of spatial interlacing comprises, for each discrete portion: randomly selecting one of the plurality of sub-holograms; and identifying a portion of the selected sub-hologram to form the discrete hologram portion.

There is provided a method of increasing the field of view of a holographic projection system. The field of the holographic projection system may be increased beyond a/the (maximum) diffraction angle of a display device of the holographic projection system. The display device may be arranged to display a hologram of a picture. The method according to the twelfth aspect comprises the steps of: dividing a target picture into a plurality of portions; calculating a sub-hologram of each portion of the target picture;
forming a hologram by randomly spatially interlacing the plurality of sub-holograms such that; and receiving light at a plurality of redirection zones of a holographic wavefront redirector. The irregular (or random) spatial interlacing may be such that the hologram comprises a sequence (e.g. arrangement or pattern) of discrete portions of the sub-holograms randomly ordered by sub-hologram. The irregular (or random) spatial interlacing may such that any patterns in the pixel arrangement of the hologram are irregular and/or any periodicity in the pixel arrangement of the hologram is greater than a dimension of the hologram. The (composite) hologram may comprise a sequence of discrete portions of the sub-holograms randomly ordered by/based on the sub-hologram. A different subset of the redirection zones of holographic wavefront redirector may be optically coupled to each sub-hologram. Each subset of redirection zones (of the first configuration of the holographic wavefront redirector) is arranged to deflect received light at a different deflection angle with respect to a propagation axis to increase a field of view of the system. In some embodiments, the redirection zones of the different subsets are arranged in correspondence with the pixel arrangement of the hologram such that pixels of each sub-hologram experience the same deflection angle.

Embodiments describe a “holographic wavefront” by way of example only. The term “holographic wavefront” is therefore used broadly to refer to the fact that at least one image or picture (or portion thereof) is formed by reconstruction from a hologram. The present disclosure is equally applicable to redirection of a conventional or non-holographic wavefront such as an image wavefront—that is, a wavefront spatially modulated in accordance with an image.

The present disclosure at least partially relates to an approach for displaying two holograms on the same display device. In some embodiments, a first hologram corresponds to a first image or picture and a second hologram corresponds to a second image or picture. In other embodiments, the first hologram corresponds to a first sub-area, zone or portion of an image or picture and the second hologram corresponds to a second sub-area, zone or portion of the (same) image or picture. The first and second sub-area may be non-overlapping or non-adjacent. The holograms in accordance with the present disclosure may be calculated by any means such as using a point cloud or iterative phase retrieval method.

In accordance with the present disclosure first and second holograms are also referred to as first and second sub-holograms to reflect that they are components of the pattern or composite “hologram” displayed on the display device. The first and second (sub-) holograms may be combined with or without discarding pixel values. By way of example only, the first and second hologram may each be half the size of the display device—e.g. use half the pixels of the display device. In alternative embodiments, the first and second (sub-) holograms are each derived from a larger hologram. The first and second (sub-) holograms may be different sizes—e.g. have a different number of pixels and/or a different aspect ratio). The first and second (sub-) holograms may be independently calculated before spatial interlacing—i.e. combining. The term “spatially interlace” is used herein to refer to any technique for combining (i.e. displaying) the two (sub-) holograms at the same time on the same display device—i.e. a “common” display device.

In summary, the wavefront redirector of the present disclosure may take any number of different forms. In some embodiments, the wavefront redirector is a hardware component—that is, a physical optical component. In other embodiments, the wavefront redirector may be described as being a software component to indicate that it is an amplitude and/or phase (light modulation) pattern displayable on a display device. The term “software component” is used to indicate that the component is reconfigurable (e.g. changeable in time unlike a hardware component e.g. optic) and representable by data that can control or drive a display device. In other embodiments, the wavefront redirector is a hybrid component comprising both a hardware component and a software component—that is, the optical functionality of the wavefront redirector is partially provided by a hardware component and partially provided by a software component.

The hardware component may be a prismatic structure comprising a first plurality of prismatic zones (or, simply, prisms) that direct light in a first (e.g. 1D) direction and a second plurality of prismatic zones (or, simply, prisms) that direct light in a second (e.g. 1D) direction opposing the first direction. The hardware component may alternatively be a physical, diffractive structure such as a diffractive optic element, “DOE”, designed to provide the optical functionality described herein. The person skilled in the art of optical design will be familiar with DOEs and how they may be designed to provide light steering based on e.g. diffraction. The present disclosure is not limited to a specific design of DOE because an infinite number of different designs may be used to provide the system of the present disclosure. Aspects of the present disclosure are therefore described by the optical functionality provided which reflects the design flexibility associated with the concept.

The software component may be a so-called grating or phase-ramp function as described below and usable in the art of dynamic holography for steering a (single) wavefront encoding a (single) hologram. In optical terms, the phase-ramps described below are relatively coarse (in terms of the feature size e.g. pixel size) and are therefore limited in terms of the maximum light redirection (angular displacement or distance) they can provide. However, in some embodiments, a “coarse” phase-ramp is adequate to implement the concept of the present disclosure. In some embodiments, a “coarse” phase-ramp function is displayed on the same display device as the hologram (of the image) or at least on a display device having the same feature size e.g. pixel size as the hologram. In some embodiments, that pixel pitch is greater than 1 micrometre. That is, the term “coarse” is used herein to mean up to 1 micrometre feature size or pixel pitch and the term “fine” is used herein to mean less than 1 micrometre. In other embodiments, a smaller (fine) pixel pitch is used to display a diffractive structure providing greater displacement (i.e. redirection) of the wavefront encoded with the hologram. That is, the system may comprise a first display device having relatively larger (coarse) pixels (e.g. at least 1 micrometre pixel pitch) for displaying the hologram of the image (or image portions) and a second display device having relatively small (fine) pixels (e.g. less than 1 micrometre pixel pitch) for displaying a diffractive pattern providing the wavefront redirection disclosed herein. In some embodiments, the diffractive pattern is “fine” grating with a relatively small pitch or periodicity for providing a larger displacement/translation/redirection.

In some embodiments, a hardware and software component are used to collectively provide the wavefront redirection described herein. These embodiments are particularly advantageous because a hardware component can be used to provide the majority of the redirection (e.g. at least 75% of the angular displacement or linear distance) and the remaining redirection (e.g. up to 25% of the angular displacement or linear distance) can be provided “in software” using a display device to allow a degree of fine-tuning or reconfiguration to address component tolerances.

In the present disclosure, the term “replica” is merely used to reflect that spatially modulated light is divided such that a complex light field is directed along a plurality of different optical paths. The word “replica” is used to refer to each occurrence or instance of the complex light field after a replication event—such as a partial reflection-transmission by a pupil expander. Each replica travels along a different optical path. Some embodiments of the present disclosure relate to propagation of light that is encoded with a hologram, not an image—i.e., light that is spatially modulated with a hologram of an image, not the image itself. It may therefore be said that a plurality of replicas of the hologram are formed. The person skilled in the art of holography will appreciate that the complex light field associated with propagation of light encoded with a hologram will change with propagation distance. Use herein of the term “replica” is independent of propagation distance and so the two branches or paths of light associated with a replication event are still referred to as “replicas” of each other even if the branches are a different length, such that the complex light field has evolved differently along each path. That is, two complex light fields are still considered “replicas” in accordance with this disclosure even if they are associated with different propagation distances-providing they have arisen from the same replication event or series of replication events.

A “diffracted light field” or “diffractive light field” in accordance with this disclosure is a light field formed by diffraction. A diffracted light field may be formed by illuminating a corresponding diffractive pattern. In accordance with this disclosure, an example of a diffractive pattern is a hologram and an example of a diffracted light field is a holographic light field or a light field forming a holographic reconstruction of an image. The holographic light field forms a (holographic) reconstruction of an image on a replay plane. The holographic light field that propagates from the hologram to the replay plane may be said to comprise light encoded with the hologram or light in the hologram domain. A diffracted light field is characterized by a diffraction angle determined by the smallest feature size of the diffractive structure and the wavelength of the light (of the diffracted light field). In accordance with this disclosure, it may also be said that a “diffracted light field” is a light field that forms a reconstruction on a plane spatially separated from the corresponding diffractive structure. An optical system is disclosed herein for propagating a diffracted light field from a diffractive structure to a viewer. The diffracted light field may form an image.

The term “hologram” is used to refer to the recording which contains amplitude information or phase information, or some combination thereof, regarding the object. The term “holographic reconstruction” is used to refer to the optical reconstruction of the object which is formed by illuminating the hologram. The system disclosed herein is described as a “holographic projector” because the holographic reconstruction is a real image and spatially-separated from the hologram. The term “replay field” is used to refer to the 2D area within which the holographic reconstruction is formed and fully focused. If the hologram is displayed on a spatial light modulator comprising pixels, the replay field will be repeated in the form of a plurality diffracted orders wherein each diffracted order is a replica of the zeroth-order replay field. The zeroth-order replay field generally corresponds to the preferred or primary replay field because it is the brightest replay field. Unless explicitly stated otherwise, the term “replay field” should be taken as referring to the zeroth-order replay field. The term “replay plane” is used to refer to the plane in space containing all the replay fields. The terms “image”, “replay image” and “image region” refer to areas of the replay field illuminated by light of the holographic reconstruction. In some embodiments, the “image” may comprise discrete spots which may be referred to as “image spots” or, for convenience only, “image pixels”.

The terms “encoding”, “writing” or “addressing” are used to describe the process of providing the plurality of pixels of the SLM with a respective plurality of control values which respectively determine the modulation level of each pixel. It may be said that the pixels of the SLM are configured to “display” a light modulation distribution in response to receiving the plurality of control values. Thus, the SLM may be said to “display” a hologram and the hologram may be considered an array of light modulation values or levels.

It has been found that a holographic reconstruction of acceptable quality can be formed from a “hologram” containing only phase information related to the Fourier transform of the original object. Such a holographic recording may be referred to as a phase-only hologram. Embodiments relate to a phase-only hologram but the present disclosure is equally applicable to amplitude-only holography.

The present disclosure is also equally applicable to forming a holographic reconstruction using amplitude and phase information related to the Fourier transform of the original object. In some embodiments, this is achieved by complex modulation using a so-called fully complex hologram which contains both amplitude and phase information related to the original object. Such a hologram may be referred to as a fully-complex hologram because the value (grey level) assigned to each pixel of the hologram has an amplitude and phase component. The value (grey level) assigned to each pixel may be represented as a complex number having both amplitude and phase components. In some embodiments, a fully-complex computer-generated hologram is calculated.

Reference may be made to the phase value, phase component, phase information or, simply, phase of pixels of the computer-generated hologram or the spatial light modulator as shorthand for “phase-delay”. That is, any phase value described is, in fact, a number (e.g. in the range 0 to 2π) which represents the amount of phase retardation provided by that pixel. For example, a pixel of the spatial light modulator described as having a phase value of π/2 will retard the phase of received light by π/2 radians. In some embodiments, each pixel of the spatial light modulator is operable in one of a plurality of possible modulation values (e.g. phase delay values). The term “grey level” may be used to refer to the plurality of available modulation levels. For example, the term “grey level” may be used for convenience to refer to the plurality of available phase levels in a phase-only modulator even though different phase levels do not provide different shades of grey. The term “grey level” may also be used for convenience to refer to the plurality of available complex modulation levels in a complex modulator.

The hologram therefore comprises an array of grey levels—that is, an array of light modulation values such as an array of phase-delay values or complex modulation values. The hologram is also considered a diffractive pattern because it is a pattern that causes diffraction when displayed on a spatial light modulator and illuminated with light having a wavelength comparable to, generally less than, the pixel pitch of the spatial light modulator. Reference is made herein to combining the hologram with other diffractive patterns such as diffractive patterns functioning as a lens or grating. For example, a diffractive pattern functioning as a grating may be combined with a hologram to translate the replay field on the replay plane or a diffractive pattern functioning as a lens may be combined with a hologram to focus the holographic reconstruction on a replay plane in the near field.

Although different embodiments and groups of embodiments may be disclosed separately in the detailed description which follows, any feature of any embodiment or group of embodiments may be combined with any other feature or combination of features of any embodiment or group of embodiments. That is, all possible combinations and permutations of features disclosed in the present disclosure are envisaged.

### BRIEF DESCRIPTION OF THE DRAWINGS

Specific embodiments are described by way of example only with reference to the following figures:

FIG. 1 is a schematic showing a reflective SLM producing a holographic reconstruction on a screen;

FIG. 2 shows an image for projection comprising eight image areas/components, V1 to V8, and cross-sections of the corresponding hologram channels, H1-H8;

FIG. 3 shows a hologram displayed on an LCOS that directs light into a plurality of discrete areas;

FIG. 4 shows a system, including a display device that displays a hologram that has been calculated as illustrated in FIGS. 2 and 3;

FIG. 5A shows a perspective view of a first example two-dimensional pupil expander comprising two replicators each comprising pairs of stacked surfaces;

FIG. 5B shows a perspective view of a first example two-dimensional pupil expander comprising two replicators each in the form of a solid waveguide;

FIG. 6 shows an example visualisation of an extended modulator formed by a waveguide;

FIG. 7 shows how light from a holographic projector in a vehicle is relayed to an eye-box;

FIG. 8A shows a schematic view of an example pixellated display device of a holographic projection system;

FIG. 8B shows the maximum diffraction angle of the pixellated display device of FIG. 8A;

FIG. 9 shows a schematic cross-sectional view of an example of a portion of a holographic projection system according to the present disclosure;

FIG. 10 schematically represents the calculation of a hologram for projection by the holographic projection system of FIG. 9;

FIG. 11 shows a cross-sectional view of a holographic wavefront redirector of the holographic projection system of FIG. 9;

FIG. 12 schematically shows how the range of angles that light is emitted from the holographic wavefront redirector compares to the diffraction angle of the display device;

FIG. 13 schematically represents the effect of the holographic wavefront redirector on the holographic reconstruction formed by the holographic projection system;

FIG. 14 schematically represents the calculation of a second hologram for projection by the holographic projection system of FIG. 9;

FIG. 15 shows a cross-sectional view of a second holographic wavefront redirector for the holographic projection system of FIG. 9 when the second hologram is displayed/projected;

FIG. 16 schematically represents the effect of the second holographic wavefront redirector on the holographic reconstruction of the second hologram formed by the holographic projection system;

FIG. 17 schematically represents the calculation of a third hologram for projection by the holographic projection system of FIG. 9;

FIG. 18 shows a cross-sectional view of a third holographic wavefront redirector for the holographic projection system of FIG. 9 when the third hologram is displayed/projected;

FIG. 19A shows a fourth (active) holographic wavefront redirector in a first configuration; and

FIG. 19B shows the fourth (active) holographic wavefront redirector in a second configuration.

The same reference numbers will be used throughout the drawings to refer to the same or like parts.

### DETAILED DESCRIPTION OF EMBODIMENTS

The present invention is not restricted to the embodiments described in the following but extends to the full scope of the appended claims. That is, the present invention may be embodied in different forms and should not be construed as limited to the described embodiments, which are set out for the purpose of illustration.

Terms of a singular form may include plural forms unless specified otherwise.

A structure described as being formed at an upper portion/lower portion of another structure or on/under the other structure should be construed as including a case where the structures contact each other and, moreover, a case where a third structure is disposed there between.

In describing a time relationship—for example, when the temporal order of events is described as “after”, “subsequent”, “next”, “before” or suchlike—the present disclosure should be taken to include continuous and non-continuous events unless otherwise specified. For example, the description should be taken to include a case which is not continuous unless wording such as “just”, “immediate” or “direct” is used.

Although the terms “first”, “second”, etc. may be used herein to describe various elements, these elements are not to be limited by these terms. These terms are only used to distinguish one element from another. For example, a first element could be termed a second element, and, similarly, a second element could be termed a first element, without departing from the scope of the appended claims.

Features of different embodiments may be partially or overall coupled to or combined with each other, and may be variously inter-operated with each other. Some embodiments may be carried out independently from each other, or may be carried out together in co-dependent relationship.

In the present disclosure, the term “substantially” when applied to a structural units of an apparatus may be interpreted as the technical feature of the structural units being produced within the technical tolerance of the method used to manufacture it.

### Conventional Optical Configuration for Holographic Projection

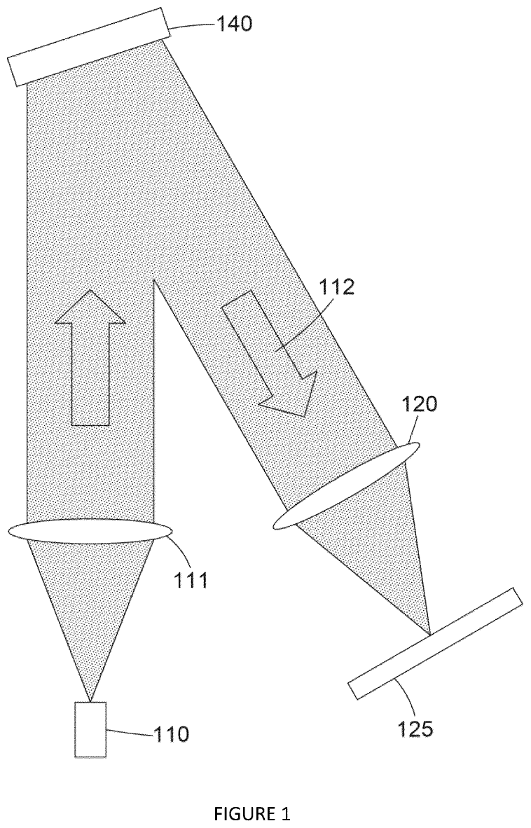

FIG. 1 shows an embodiment in which a computer-generated hologram is encoded on a single spatial light modulator. The computer-generated hologram is a Fourier transform of the object for reconstruction. It may therefore be said that the hologram is a Fourier domain or frequency domain or spectral domain representation of the object. In this embodiment, the spatial light modulator is a reflective liquid crystal on silicon, “LCOS”, device. The hologram is encoded on the spatial light modulator and a holographic reconstruction is formed at a replay field, for example, a light receiving surface such as a screen or diffuser.

A light source 110, for example a laser or laser diode, is disposed to illuminate the SLM 140 via a collimating lens 111. The collimating lens causes a generally planar wavefront of light to be incident on the SLM. In FIG. 1, the direction of the wavefront is off-normal (e.g. two or three degrees away from being truly orthogonal to the plane of the transparent layer). However, in other embodiments, the generally planar wavefront is provided at normal incidence and a beam splitter arrangement is used to separate the input and output optical paths. In the embodiment shown in FIG. 1, the arrangement is such that light from the light source is reflected off a mirrored rear surface of the SLM and interacts with a light-modulating layer to form an exit wavefront 112. The exit wavefront 112 is applied to optics including a Fourier transform lens 120, having its focus at a screen 125. More specifically, the Fourier transform lens 120 receives a beam of modulated light from the SLM 140 and performs a frequency-space transformation to produce a holographic reconstruction at the screen 125.

Notably, in this type of holography, each pixel of the hologram contributes to the whole reconstruction. There is not a one-to-one correlation between specific points (or image pixels) on the replay field and specific light-modulating elements (or hologram pixels). In other words, modulated light exiting the light-modulating layer is distributed across the replay field.

In these embodiments, the position of the holographic reconstruction in space is determined by the dioptric (focusing) power of the Fourier transform lens. In the embodiment shown in FIG. 1, the Fourier transform lens is a physical lens. That is, the Fourier transform lens is an optical Fourier transform lens and the Fourier transform is performed optically. Any lens can act as a Fourier transform lens but the performance of the lens will limit the accuracy of the Fourier transform it performs. The skilled person understands how to use a lens to perform an optical Fourier transform In some embodiments of the present disclosure, the lens of the viewer's eye performs the hologram to image transformation.

### Hologram Calculation

In some embodiments, the computer-generated hologram is a Fourier transform hologram, or simply a Fourier hologram or Fourier-based hologram, in which an image is reconstructed in the far field by utilising the Fourier transforming properties of a positive lens. The Fourier hologram is calculated by Fourier transforming the desired light field in the replay plane back to the lens plane. Computer-generated Fourier holograms may be calculated using Fourier transforms. Embodiments relate to Fourier holography and Gerchberg-Saxton type algorithms by way of example only. The present disclosure is equally applicable to Fresnel holography and Fresnel holograms which may be calculated by a similar method. In some embodiments, the hologram is a phase or phase-only hologram. However, the present disclosure is also applicable to holograms calculated by other techniques such as those based on point cloud methods.

In some embodiments, the hologram engine is arranged to exclude from the hologram calculation the contribution of light blocked by a limiting aperture of the display system. British patent application 2101666.2, filed 5 Feb. 2021 and incorporated herein by reference, discloses a first hologram calculation method in which eye-tracking and ray tracing are used to identify a sub-area of the display device for calculation of a point cloud hologram which eliminates ghost images. The sub-area of the display device corresponds with the aperture, of the present disclosure, and is used exclude light paths from the hologram calculation. British patent application 2112213.0, filed 26 Aug. 2021 and incorporated herein by reference, discloses a second method based on a modified Gerchberg-Saxton type algorithm which includes steps of light field cropping in accordance with pupils of the optical system during hologram calculation. The cropping of the light field corresponds with the determination of a limiting aperture of the present disclosure. British patent application 2118911.3, filed 23 Dec. 2021 and also incorporated herein by reference, discloses a third method of calculating a hologram which includes a step of determining a region of a so-called extended modulator formed by a hologram replicator. The region of the extended modulator is also an aperture in accordance with this disclosure.

In some embodiments, there is provided a real-time engine arranged to receive image data and calculate holograms in real-time using the algorithm. In some embodiments, the image data is a video comprising a sequence of image frames. In other embodiments, the holograms are pre-calculated, stored in computer memory and recalled as needed for display on a SLM. That is, in some embodiments, there is provided a repository of predetermined holograms.

### Pupil Expansion

Broadly, the present disclosure relates to image projection. It relates to a method of image projection and an image projector which comprises a display device. The present disclosure also relates to a projection system comprising the image projector and a viewing system, in which the image projector projects or relays light from the display device to the viewing system. The present disclosure is equally applicable to a monocular and binocular viewing system. The viewing system may comprise a viewer's eye or eyes. The viewing system comprises an optical element having optical power (e.g., lens/es of the human eye) and a viewing plane (e.g., retina of the human eye/s). The projector may be referred to as a ‘light engine’. The display device and the image formed (or perceived) using the display device are spatially separated from one another. The image is formed, or perceived by a viewer, on a display plane. In some embodiments, the image is a virtual image and the display plane may be referred to as a virtual image plane. In other examples, the image is a real image formed by holographic reconstruction and the image is projected or relayed to the viewing plane. In these other examples, spatially modulated light of an intermediate holographic reconstruction formed either in free space or on a screen or other light receiving surface between the display device and the viewer, is propagated to the viewer. In both cases, an image is formed by illuminating a diffractive pattern (e.g., hologram or kinoform) displayed on the display device.

The display device comprises pixels. The pixels of the display may display a diffractive pattern or structure that diffracts light. The diffracted light may form an image at a plane spatially separated from the display device. In accordance with well-understood optics, the magnitude of the maximum diffraction angle is determined by the size of the pixels and other factors such as the wavelength of the light.

In embodiments, the display device is a spatial light modulator such as liquid crystal on silicon (“LCOS”) spatial light modulator (SLM). Light propagates over a range of diffraction angles (for example, from zero to the maximum diffractive angle) from the LCOS, towards a viewing entity/system such as a camera or an eye. In some embodiments, magnification techniques may be used to increase the range of available diffraction angles beyond the conventional maximum diffraction angle of an LCOS.

In some embodiments, the (light of a) hologram itself is propagated to the eyes. For example, spatially modulated light of the hologram (that has not yet been fully transformed to a holographic reconstruction, i.e. image)—that may be informally said to be “encoded” with/by the hologram—is propagated directly to the viewer's eyes. A real or virtual image may be perceived by the viewer. In these embodiments, there is no intermediate holographic reconstruction/image formed between the display device and the viewer. It is sometimes said that, in these embodiments, the lens of the eye performs a hologram-to-image conversion or transform. The projection system, or light engine, may be configured so that the viewer effectively looks directly at the display device.

Reference is made herein to a “light field” which is a “complex light field”. The term “light field” merely indicates a pattern of light having a finite size in at least two orthogonal spatial directions, e.g. x and y. The word “complex” is used herein merely to indicate that the light at each point in the light field may be defined by an amplitude value and a phase value, and may therefore be represented by a complex number or a pair of values. For the purpose of hologram calculation, the complex light field may be a two-dimensional array of complex numbers, wherein the complex numbers define the light intensity and phase at a plurality of discrete locations within the light field.

In accordance with the principles of well-understood optics, the range of angles of light propagating from a display device that can be viewed, by an eye or other viewing entity/system, varies with the distance between the display device and the viewing entity. At a 1 metre viewing distance, for example, only a small range of angles from an LCOS can propagate through an eye's pupil to form an image at the retina for a given eye position. The range of angles of light rays that are propagated from the display device, which can successfully propagate through an eye's pupil to form an image at the retina for a given eye position, determines the portion of the image that is ‘visible’ to the viewer. In other words, not all parts of the image are visible from any one point on the viewing plane (e.g., any one eye position within a viewing window such as eye-box.)

In some embodiments, the image perceived by a viewer is a virtual image that appears upstream of the display device—that is, the viewer perceives the image as being further away from them than the display device. Conceptually, it may therefore be considered that the viewer is looking at a virtual image through an ‘display device-sized window’, which may be very small, for example 1 cm in diameter, at a relatively large distance, e.g., 1 metre. And the user will be viewing the display device-sized window via the pupil(s) of their eye(s), which can also be very small. Accordingly, the field of view becomes small and the specific angular range that can be seen depends heavily on the eye position, at any given time.

A pupil expander addresses the problem of how to increase the range of angles of light rays that are propagated from the display device that can successfully propagate through an eye's pupil to form an image. The display device is generally (in relative terms) small and the projection distance is (in relative terms) large. In some embodiments, the projection distance is at least one—such as, at least two—orders of magnitude greater than the diameter, or width, of the entrance pupil and/or aperture of the display device (i.e., size of the array of pixels).

Use of a pupil expander increases the viewing area (i.e., user's eye-box) laterally, thus enabling some movement of the eye/s to occur, whilst still enabling the user to see the image. As the skilled person will appreciate, in an imaging system, the viewing area (user's eye box) is the area in which a viewer's eyes can perceive the image. The present disclosure encompasses non-infinite virtual image distances—that is, near-field virtual images.

Conventionally, a two-dimensional pupil expander comprises one or more one-dimensional optical waveguides each formed using a pair of opposing reflective surfaces, in which the output light from a surface forms a viewing window or eye-box. Light received from the display device (e.g., spatially modulated light from a LCOS) is replicated by the or each waveguide so as to increase the field of view (or viewing area) in at least one dimension. In particular, the waveguide enlarges the viewing window due to the generation of extra rays or “replicas” by division of amplitude of the incident wavefront.

The display device may have an active or display area having a first dimension that may be less than 10 cms such as less than 5 cms or less than 2 cms. The propagation distance between the display device and viewing system may be greater than 1 m such as greater than 1.5 m or greater than 2 m. The optical propagation distance within the waveguide may be up to 2 m such as up to 1.5 m or up to 1 m. The method may be capable of receiving an image and determining a corresponding hologram of sufficient quality in less than 20 ms such as less than 15 ms or less than 10 ms.

In some embodiments—described only by way of example of a diffracted or holographic light field in accordance with this disclosure—a hologram is configured to route light into a plurality of channels, each channel corresponding to a different part (i.e. sub-area) of an image. The channels formed by the diffractive structure are referred to herein as “hologram channels” merely to reflect that they are channels of light encoded by the hologram with image information. It may be said that the light of each channel is in the hologram domain rather than the image or spatial domain. In some embodiments, the hologram is a Fourier or Fourier transform hologram and the hologram domain is therefore the Fourier or frequency domain. The hologram may equally be a Fresnel or Fresnel transform hologram. The hologram may also be a point cloud hologram. The hologram is described herein as routing light into a plurality of hologram channels to reflect that the image that can be reconstructed from the hologram has a finite size and can be arbitrarily divided into a plurality of image sub-areas, wherein each hologram channel would correspond to each image sub-area. Importantly, the hologram of this example is characterised by how it distributes the image content when illuminated. Specifically and uniquely, the hologram divides the image content by angle. That is, each point on the image is associated with a unique light ray angle in the spatially modulated light formed by the hologram when illuminated—at least, a unique pair of angles because the hologram is two-dimensional. For the avoidance of doubt, this hologram behaviour is not conventional. The spatially modulated light formed by this special type of hologram, when illuminated, may be divided into a plurality of hologram channels, wherein each hologram channel is defined by a range of light ray angles (in two-dimensions). It will be understood from the foregoing that any hologram channel (i.e. sub-range of light ray angles) that may be considered in the spatially modulated light will be associated with a respective part or sub-area of the image. That is, all the information needed to reconstruct that part or sub-area of the image is contained within a sub-range of angles of the spatially modulated light formed from the hologram of the image. When the spatially modulated light is observed as a whole, there is not necessarily any evidence of a plurality of discrete light channels.

Nevertheless, the hologram may still be identified. For example, if only a continuous part or sub-area of the spatially modulated light formed by the hologram is reconstructed, only a sub-area of the image should be visible. If a different, continuous part or sub-area of the spatially modulated light is reconstructed, a different sub-area of the image should be visible. A further identifying feature of this type of hologram is that the shape of the cross-sectional area of any hologram channel substantially corresponds to (i.e. is substantially the same as) the shape of the entrance pupil although the size may be different—at least, at the correct plane for which the hologram was calculated. Each light/hologram channel propagates from the hologram at a different angle or range of angles. Whilst these are example ways of characterising or identifying this type of hologram, other ways may be used. In summary, the hologram disclosed herein is characterised and identifiable by how the image content is distributed within light encoded by the hologram. Again, for the avoidance of any doubt, reference herein to a hologram configured to direct light or angularly-divide an image into a plurality of hologram channels is made by way of example only and the present disclosure is equally applicable to pupil expansion of any type of holographic light field or even any type of diffractive or diffracted light field.

The system can be provided in a compact and streamlined physical form. This enables the system to be suitable for a broad range of real-world applications, including those for which space is limited and real-estate value is high. For example, it may be implemented in a head-up display (HUD) such as a vehicle or automotive HUD.

In accordance with the present disclosure, pupil expansion is provided for diffracted or diffractive light, which may comprise diverging ray bundles. The diffracted light field may be defined by a “light cone”. Thus, the size of the diffracted light field (as defined on a two-dimensional plane) increases with propagation distance from the corresponding diffractive structure (i.e. display device). It can be said that the pupil expander/s replicate the hologram or form at least one replica of the hologram, to convey that the light delivered to the viewer is spatially modulated in accordance with a hologram.

In some embodiments, two one-dimensional waveguide pupil expanders are provided, each one-dimensional waveguide pupil expander being arranged to effectively increase the size of the exit pupil of the system by forming a plurality of replicas or copies of the exit pupil (or light of the exit pupil) of the spatial light modulator. The exit pupil may be understood to be the physical area from which light is output by the system. It may also be said that each waveguide pupil expander is arranged to expand the size of the exit pupil of the system. It may also be said that each waveguide pupil expander is arranged to expand/increase the size of the eye box within which a viewer's eye can be located, in order to see/receive light that is output by the system.

### Light Channelling

The hologram formed in accordance with some embodiments, angularly-divides the image content to provide a plurality of hologram channels which may have a cross-sectional shape defined by an aperture of the optical system. The hologram is calculated to provide this channelling of the diffracted light field. In some embodiments, this is achieved during hologram calculation by considering an aperture (virtual or real) of the optical system, as described above.

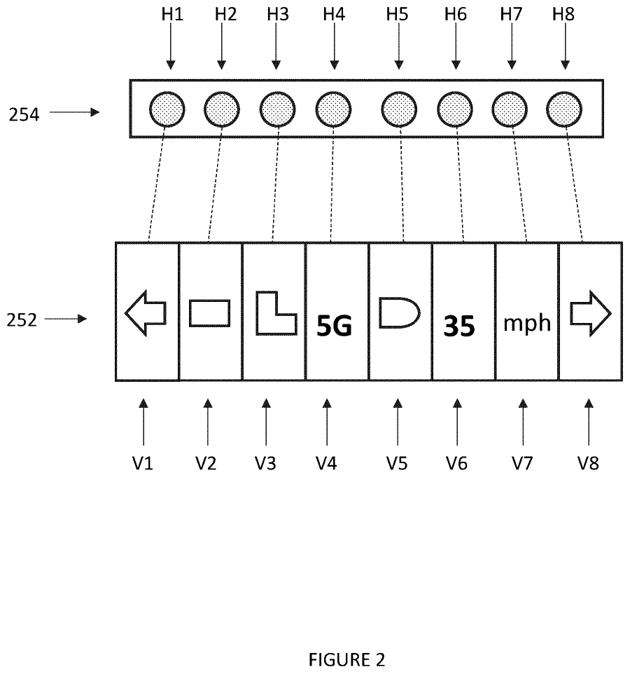

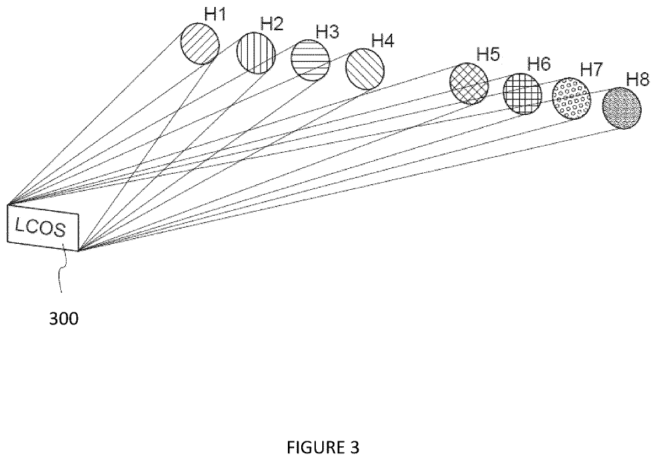

FIGS. 2 and 3 show an example of this type of hologram that may be used in conjunction with a pupil expander as disclosed herein. However, this example should not be regarded as limiting with respect to the present disclosure.

FIG. 2 shows an image 252 for projection comprising eight image areas/components, V1 to V8. FIG. 2 shows eight image components by way of example only and the image 252 may be divided into any number of components. FIG. 2 also shows an encoded light pattern 254 (i.e., hologram) that can reconstruct the image 252—e.g., when transformed by the lens of a suitable viewing system. The encoded light pattern 254 comprises first to eighth sub-holograms or components, H1 to H8, corresponding to the first to eighth image components/areas, V1 to V8. FIG. 2 further shows how a hologram may decompose the image content by angle. The hologram may therefore be characterised by the channelling of light that it performs. This is illustrated in FIG. 3. Specifically, the hologram in this example directs light into a plurality of discrete areas. The discrete areas are discs in the example shown but other shapes are envisaged. The size and shape of the optimum disc may, after propagation through the waveguide, be related to the size and shape of an aperture of the optical system such as the entrance pupil of the viewing system.

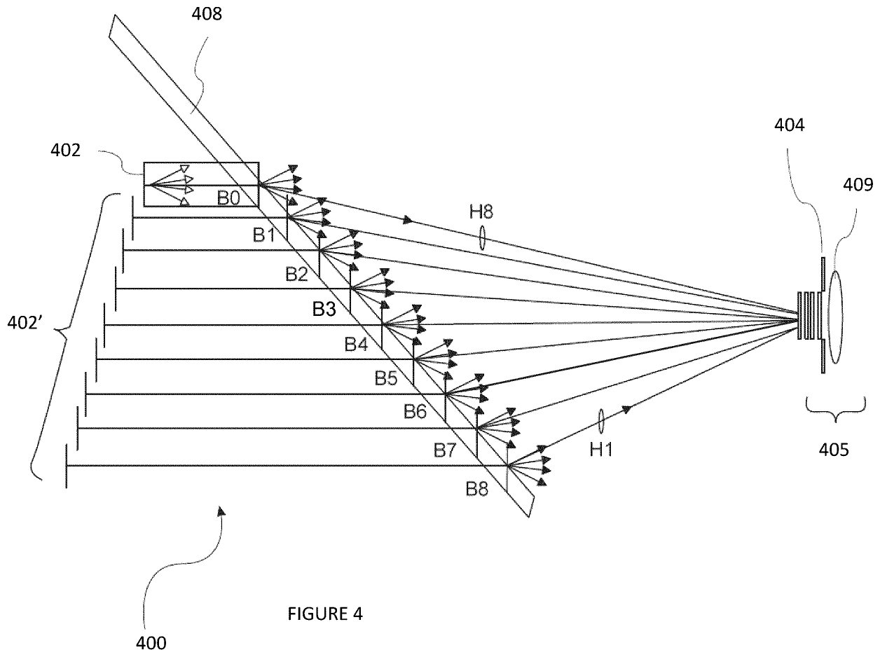

FIG. 4 shows a system 400, including a display device that displays a hologram that has been calculated as illustrated in FIGS. 2 and 3.

The system 400 comprises a display device, which in this arrangement comprises an LCOS 402. The LCOS 402 is arranged to display a modulation pattern (or ‘diffractive pattern’) comprising the hologram and to project light that has been holographically encoded towards an eye 405 that comprises a pupil that acts as an aperture 404, a lens 409, and a retina (not shown) that acts as a viewing plane. There is a light source (not shown) arranged to illuminate the LCOS 402. The lens 409 of the eye 405 performs a hologram-to-image transformation. The light source may be of any suitable type. For example, it may comprise a laser light source.

The viewing system 400 further comprises a waveguide 408 positioned between the LCOS 402 and the eye 405. The presence of the waveguide 408 enables all angular content from the LCOS 402 to be received by the eye, even at the relatively large projection distance shown. This is because the waveguide 508 acts as a pupil expander, in a manner that is well known and so is described only briefly herein.

In brief, the waveguide 408 shown in FIG. 4 comprises a substantially elongate formation. In this example, the waveguide 408 comprises an optical slab of refractive material, but other types of waveguide are also well known and may be used. The waveguide 408 is located so as to intersect the light cone (i.e., the diffracted light field) that is projected from the LCOS 402, for example at an oblique angle. In this example, the size, location, and position of the waveguide 408 are configured to ensure that light from each of the eight ray bundles, within the light cone, enters the waveguide 408. Light from the light cone enters the waveguide 408 via its first planar surface (located nearest the LCOS 402) and is guided at least partially along the length of the waveguide 408, before being emitted via its second planar surface, substantially opposite the first surface (located nearest the eye). As will be well understood, the second planar surface is partially reflective, partially transmissive. In other words, when each ray of light travels within the waveguide 408 from the first planar surface and hits the second planar surface, some of the light will be transmitted out of the waveguide 408 and some will be reflected by the second planar surface, back towards the first planar surface. The first planar surface is reflective, such that all light that hits it, from within the waveguide 408, will be reflected back towards the second planar surface. Therefore, some of the light may simply be refracted between the two planar surfaces of the waveguide 408 before being transmitted, whilst other light may be reflected, and thus may undergo one or more reflections, (or ‘bounces’) between the planar surfaces of the waveguide 408, before being transmitted.

FIG. 4 shows a total of nine “bounce” points, B0 to B8, along the length of the waveguide 408. Although light relating to all points of the image (V1-V8) as shown in FIG. 2 is transmitted out of the waveguide at each “bounce” from the second planar surface of the waveguide 408, only the light from one angular part of the image (e.g. light of one of V1 to V8) has a trajectory that enables it to reach the eye 405, from each respective “bounce” point, B0 to B8. Moreover, light from a different angular part of the image, V1 to V8, reaches the eye 405 from each respective “bounce” point. Therefore, each angular channel of encoded light reaches the eye only once, from the waveguide 408, in the example of FIG. 4.

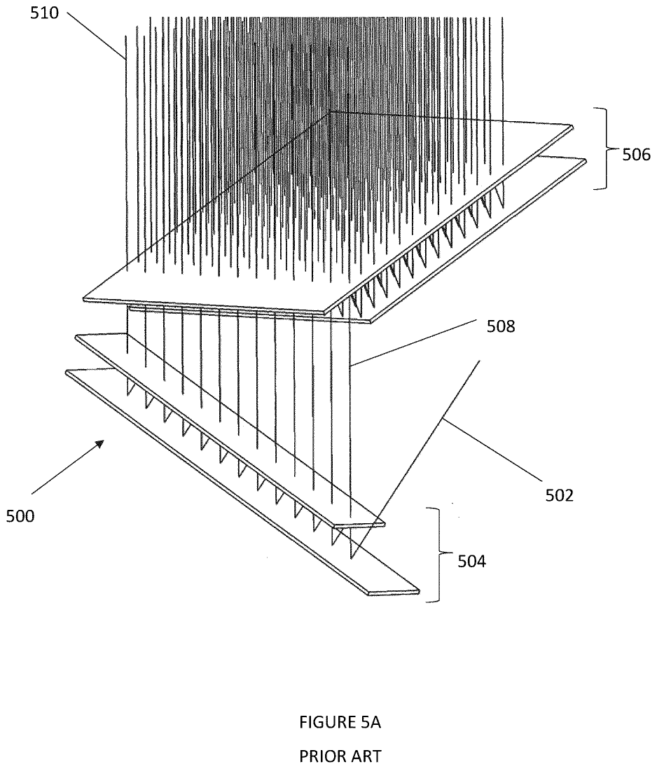

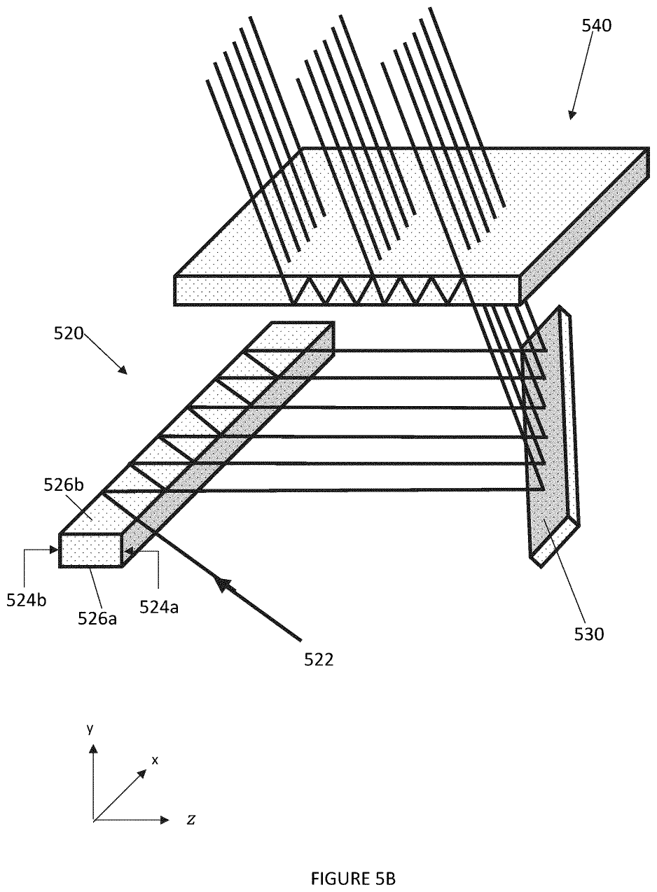

The waveguide 408 forms a plurality of replicas of the hologram, at the respective “bounce” points B1 to B8 along its length, corresponding to the direction of pupil expansion. As shown in FIG. 5, the plurality of replicas may be extrapolated back, in a straight line, to a corresponding plurality of replica or virtual display devices 402′. This process corresponds to the step of “unfolding” an optical path within the waveguide, so that a light ray of a replica is extrapolated back to a “virtual surface” without internal reflection within the waveguide. Thus, the light of the expanded exit pupil may be considered to originate from a virtual surface (also called an “extended modulator” herein) comprising the display device 402 and the replica display devices 402′.

Although virtual images, which require the eye to transform received modulated light in order to form a perceived image, have generally been discussed herein, the methods and arrangements described herein can be applied to real images.

### Two-Dimensional Pupil Expansion

Whilst the arrangement shown in FIG. 4 includes a single waveguide that provides pupil expansion in one dimension, pupil expansion can be provided in more than one dimension, for example in two dimensions. Moreover, whilst the example in FIG. 4 uses a hologram that has been calculated to create channels of light, each corresponding to a different portion of an image, the present disclosure and the systems that are described herebelow are not limited to such a hologram type.

FIG. 5A shows a perspective view of a system 500 comprising two replicators, 504, 506 arranged for expanding a light beam 502 in two dimensions.

In the system 500 of FIG. 5A, the first replicator 504 comprises a first pair of surfaces, stacked parallel to one another, and arranged to provide replication—or, pupil expansion—in a similar manner to the waveguide 408 of FIG. 4. The first pair of surfaces are similarly (in some cases, identically) sized and shaped to one another and are substantially elongate in one direction. The collimated light beam 502 is directed towards an input on the first replicator 504. Due to a process of internal reflection between the two surfaces, and partial transmission of light from each of a plurality of output points on one of the surfaces (the upper surface, as shown in FIG. 5A), which will be familiar to the skilled reader, light of the light beam 502 is replicated in a first direction, along the length of the first replicator 504. Thus, a first plurality of replica light beams 508 is emitted from the first replicator 504, towards the second replicator 506.

The second replicator 506 comprises a second pair of surfaces stacked parallel to one another, arranged to receive each of the collimated light beams of the first plurality of light beams 508 and further arranged to provide replication—or, pupil expansion—by expanding each of those light beams in a second direction, substantially orthogonal to the first direction. The first pair of surfaces are similarly (in some cases, identically) sized and shaped to one another and are substantially rectangular. The rectangular shape is implemented for the second replicator in order for it to have length along the first direction, in order to receive the first plurality of light beams 508, and to have length along the second, orthogonal direction, in order to provide replication in that second direction. Due to a process of internal reflection between the two surfaces, and partial transmission of light from each of a plurality of output points on one of the surfaces (the upper surface, as shown in FIG. 5A), light of each light beam within the first plurality of light beams 508 is replicated in the second direction. Thus, a second plurality of light beams 510 is emitted from the second replicator 506, wherein the second plurality of light beams 510 comprises replicas of the input light beam 502 along each of the first direction and the second direction. Thus, the second plurality of light beams 510 may be regarded as comprising a two-dimensional grid, or array, of replica light beams.

Thus, it can be said that the first and second replicators 504, 505 of FIG. 5A combine to provide a two-dimensional replicator (or, “two-dimensional pupil expander”). Thus, the replica light beams 510 may be emitted along an optical path to an expanded eye-box of a display system, such as a head-up display.

In the system of FIG. 5A, the first replicator 504 is a waveguide comprising a pair of elongate rectilinear reflective surfaces, stacked parallel to one another, and, similarly, the second replicator 504 is a waveguide comprising a pair of rectangular reflective surfaces, stacked parallel to one another. In other systems, the first replicator may be a solid elongate rectilinear waveguide and the second replicator may be a solid planar rectangular shaped waveguide, wherein each waveguide comprises an optically transparent solid material such as glass. In this case, the pair of parallel reflective surfaces are formed by a pair of opposed major sidewalls optionally comprising respective reflective and reflective-transmissive surface coatings, familiar to the skilled reader.

FIG. 5B shows a perspective view of a system 500 comprising two replicators, 520, 540 arranged for replicating a light beam 522 in two dimensions, in which the first replicator is a solid elongated waveguide 520 and the second replicator is a solid planar waveguide 540.

In the system of FIG. 5B, the first replicator/waveguide 520 is arranged so that its pair of elongate parallel reflective surfaces 524a, 524b are perpendicular to the plane of the second replicator/waveguide 540. Accordingly, the system comprises an optical coupler arranged to couple light from an output port of first replicator 520 into an input port of the second replicator 540. In the illustrated arrangement, the optical coupler is a planar/fold mirror 530 arranged to fold or turn the optical path of light to achieve the required optical coupling from the first replicator to the second replicator. As shown in FIG. 5B, the mirror 530 is arranged to receive light-comprising a one-dimensional array of replicas extending in the first dimension—from the output port/reflective-transmissive surface 524a of the first replicator/waveguide 520. The mirror 530 is tilted so as to redirect the received light onto an optical path to an input port in the (fully) reflective surface of second replicator 540 at an angle to provide waveguiding and replica formation, along its length in the second dimension. It will be appreciated that the mirror 530 is one example of an optical element that can redirect the light in the manner shown, and that one or more other elements may be used instead, to perform this task.

In the illustrated arrangement, the (partially) reflective-transmissive surface 524a of the first replicator 520 is adjacent the input port of the first replicator/waveguide 520 that receives input beam 522 at an angle to provide waveguiding and replica formation, along its length in the first dimension. Thus, the input port of first replicator/waveguide 520 is positioned at an input end thereof at the same surface as the reflective-transmissive surface 524a. The skilled reader will understand that the input port of the first replicator/waveguide 520 may be at any other suitable position.

Accordingly, the arrangement of FIG. 5B enables the first replicator 520 and the mirror 530 to be provided as part of a first relatively thin layer in a plane in the first and third dimensions (illustrated as an x-z plane). In particular, the size or “height” of a first planar layer—in which the first replicator 520 is located—in the second dimension (illustrated as the y dimension) is reduced. The mirror 530 is configured to direct the light away from a first layer/plane, in which the first replicator 520 is located (i.e. the “first planar layer”), and direct it towards a second layer/plane, located above and substantially parallel to the first layer/plane, in which the second replicator 540 is located (i.e. a “second planar layer”). Thus, the overall size or “height” of the system—comprising the first and second replicators 520, 540 and the mirror 530 located in the stacked first and second planar layers in the first and third dimensions (illustrated as an x-z plane)—in the second dimension (illustrated as the y dimension) is compact. The skilled reader will understand that many variations of the arrangement of FIG. 5B for implementing the present disclosure are possible and contemplated.

The image projector may be arranged to project a diverging or diffracted light field. In some embodiments, the light field is encoded with a hologram. In some embodiments, the diffracted light field comprises diverging ray bundles. In some embodiments, the image formed by the diffracted light field is a virtual image.

In some embodiments, the first pair of parallel/complementary surfaces are elongate or elongated surfaces, being relatively long along a first dimension and relatively short along a second dimension, for example being relatively short along each of two other dimensions, with each dimension being substantially orthogonal to each of the respective others. The process of reflection/transmission of the light between/from the first pair of parallel surfaces is arranged to cause the light to propagate within the first waveguide pupil expander, with the general direction of light propagation being in the direction along which the first waveguide pupil expander is relatively long (i.e., in its “elongate” direction).

There is disclosed herein a system that forms an image using diffracted light and provides an eye-box size and field of view suitable for real-world application—e.g. in the automotive industry by way of a head-up display. The diffracted light is light forming a holographic reconstruction of the image from a diffractive structure—e.g. hologram such as a Fourier or Fresnel hologram. The use diffraction and a diffractive structure necessitates a display device with a high density of very small pixels (e.g. 1 micrometer)—which, in practice, means a small display device (e.g. 1 cm). The inventors have addressed a problem of how to provide 2D pupil expansion with a diffracted light field e.g. diffracted light comprising diverging (not collimated) ray bundles.

In some embodiments, the display system comprises a display device-such as a pixelated display device, for example a spatial light modulator (SLM) or Liquid Crystal on Silicon (LCoS) SLM—which is arranged to provide or form the diffracted or diverging light. In such aspects, the aperture of the spatial light modulator (SLM) is a limiting aperture of the system. That is, the aperture of the spatial light modulator—more specifically, the size of the area delimiting the array of light modulating pixels comprised within the SLM-determines the size (e.g. spatial extent) of the light ray bundle that can exit the system. In accordance with this disclosure, it is stated that the exit pupil of the system is expanded to reflect that the exit pupil of the system (that is limited by the small display device having a pixel size for light diffraction) is made larger or bigger or greater in spatial extend by the use of at least one pupil expander.

The diffracted or diverging light field may be said to have “a light field size”, defined in a direction substantially orthogonal to a propagation direction of the light field. Because the light is diffracted/diverging, the light field size increases with propagation distance.

In some embodiments, the diffracted light field is spatially-modulated in accordance with a hologram. In other words, in such aspects, the diffractive light field comprises a “holographic light field”. The hologram may be displayed on a pixelated display device. The hologram may be a computer-generated hologram (CGH). It may be a Fourier hologram or a Fresnel hologram or a point-cloud hologram or any other suitable type of hologram. The hologram may, optionally, be calculated so as to form channels of hologram light, with each channel corresponding to a different respective portion of an image that is intended to be viewed (or perceived, if it is a virtual image) by the viewer. The pixelated display device may be configured to display a plurality of different holograms, in succession or in sequence. Each of the aspects and embodiments disclosed herein may be applied to the display of multiple holograms.

The output port of the first waveguide pupil expander may be coupled to an input port of a second waveguide pupil expander. The second waveguide pupil expander may be arranged to guide the diffracted light field-including some of, preferably most of, preferably all of, the replicas of the light field that are output by the first waveguide pupil expander—from its input port to a respective output port by internal reflection between a third pair of parallel surfaces of the second waveguide pupil expander.

The first waveguide pupil expander may be arranged to provide pupil expansion, or replication, in a first direction and the second waveguide pupil expander may be arranged to provide pupil expansion, or replication, in a second, different direction. The second direction may be substantially orthogonal to the first direction. The second waveguide pupil expander may be arranged to preserve the pupil expansion that the first waveguide pupil expander has provided in the first direction and to expand (or, replicate) some of, preferably most of, preferably all of, the replicas that it receives from the first waveguide pupil expander in the second, different direction. The second waveguide pupil expander may be arranged to receive the light field directly or indirectly from the first waveguide pupil expander. One or more other elements may be provided along the propagation path of the light field between the first and second waveguide pupil expanders.

The first waveguide pupil expander may be substantially elongated and the second waveguide pupil expander may be substantially planar. The elongated shape of the first waveguide pupil expander may be defined by a length along a first dimension. The planar, or rectangular, shape of the second waveguide pupil expander may be defined by a length along a first dimension and a width, or breadth, along a second dimension substantially orthogonal to the first dimension. A size, or length, of the first waveguide pupil expander along its first dimension make correspond to the length or width of the second waveguide pupil expander along its first or second dimension, respectively. A first surface of the pair of parallel surfaces of the second waveguide pupil expander, which comprises its input port, may be shaped, sized, and/or located so as to correspond to an area defined by the output port on the first surface of the pair of parallel surfaces on the first waveguide pupil expander, such that the second waveguide pupil expander is arranged to receive each of the replicas output by the first waveguide pupil expander.

The first and second waveguide pupil expander may collectively provide pupil expansion in a first direction and in a second direction perpendicular to the first direction, optionally, wherein a plane containing the first and second directions is substantially parallel to a plane of the second waveguide pupil expander. In other words, the first and second dimensions that respectively define the length and breadth of the second waveguide pupil expander may be parallel to the first and second directions, respectively, (or to the second and first directions, respectively) in which the waveguide pupil expanders provide pupil expansion. The combination of the first waveguide pupil expander and the second waveguide pupil expander may be generally referred to as being a “pupil expander”.

It may be said that the expansion/replication provided by the first and second waveguide expanders has the effect of expanding an exit pupil of the display system in each of two directions. An area defined by the expanded exit pupil may, in turn define an expanded eye-box area, from which the viewer can receive light of the input diffracted or diverging light field. The eye-box area may be said to be located on, or to define, a viewing plane.

The two directions in which the exit pupil is expanded may be coplanar with, or parallel to, the first and second directions in which the first and second waveguide pupil expanders provide replication/expansion. Alternatively, in arrangements that comprise other elements such as an optical combiner, for example the windscreen (or, windshield) of a vehicle, the exit pupil may be regarded as being an exit pupil from that other element, such as from the windscreen. In such arrangements, the exit pupil may be non-coplanar and non-parallel with the first and second directions in which the first and second waveguide pupil expanders provide replication/expansion. For example, the exit pupil may be substantially perpendicular to the first and second directions in which the first and second waveguide pupil expanders provide replication/expansion.

The viewing plane, and/or the eye-box area, may be non-coplanar or non-parallel to the first and second directions in which the first and second waveguide pupil expanders provide replication/expansion. For example, a viewing plane may be substantially perpendicular to the first and second directions in which the first and second waveguide pupil expanders provide replication/expansion.

In order to provide suitable launch conditions to achieve internal reflection within the first and second waveguide pupil expanders, an elongate dimension of the first waveguide pupil expander may be tilted relative to the first and second dimensions of the second waveguide pupil expander.

### Combiner Shape Compensation

An advantage of projecting a hologram to the eye-box is that optical compensation can be encoded in the hologram (see, for example, European patent 2936252 incorporated herein by herein). The present disclosure is compatible with holograms that compensate for the complex curvature of an optical combiner used as part of the projection system. In some embodiments, the optical combiner is the windscreen of a vehicle. Full details of this approach are provided in European patent 2936252 and are not repeated here because the detailed features of those systems and methods are not essential to the new teaching of this disclosure herein and are merely exemplary of configurations that benefit from the teachings of the present disclosure.

### Control Device

The present disclosure is also compatible with optical configurations that include a control device (e.g. light shuttering device) to control the delivery of light from a light channelling hologram to the viewer. The holographic projector may further comprise a control device arranged to control the delivery of angular channels to the eye-box position. British patent application 2108456.1, filed 14 Jun. 2021 and incorporated herein by reference, discloses the at least one waveguide pupil expander and control device. The reader will understand from at least this prior disclosure that the optical configuration of the control device is fundamentally based upon the eye-box position of the user and is compatible with any hologram calculation method that achieves the light channeling described herein. It may be said that the control device is a light shuttering or aperturing device. The light shuttering device may comprise a 1D array of apertures or windows, wherein each aperture or window independently switchable between a light transmissive and a light non-transmissive state in order to control the deliver of hologram light channels, and their replicas, to the eye-box. Each aperture or window may comprise a plurality of liquid crystal cells or pixels.

### Virtual Replicas of the Display Device Formed by the Waveguide or Waveguides

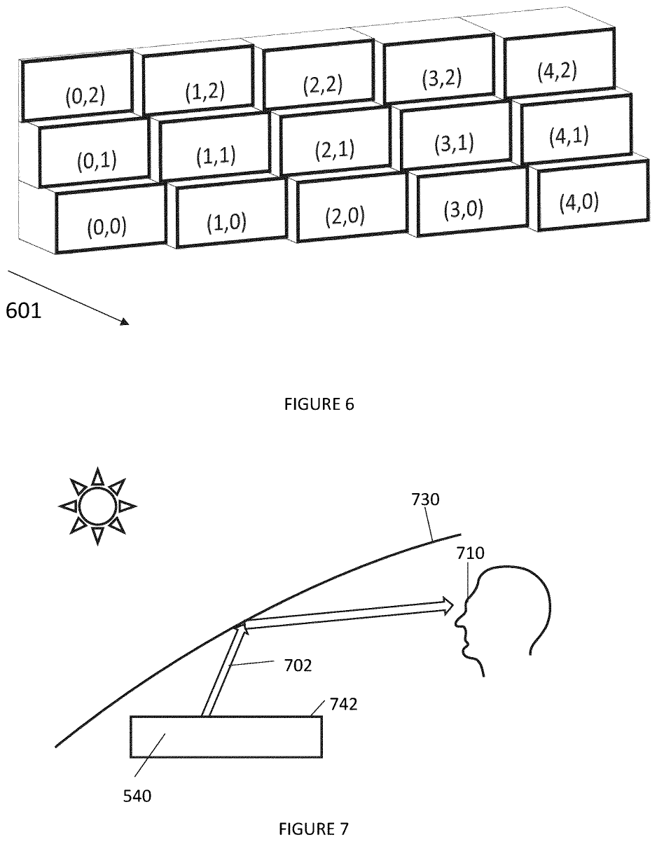

FIG. 6 shows an example visualisation of an “extended modulator” or “virtual surface” comprising a 3D array including a hologram formed on a display device and a plurality of replicas of the hologram formed by a waveguide.

As noted above with reference to FIG. 4, a one-dimensional waveguide 408 may be arranged to expand the exit pupil of a display system. The display system comprises a display device 402 displaying a hologram, which is output at “bounce” point B0 of waveguide 408. In addition, the waveguide forms a plurality of replicas of the hologram, at respective “bounce” points B1 to B8 along its length, corresponding to the direction of pupil expansion. As shown in FIG. 4, the plurality of replicas may be extrapolated back, in a straight line, to a corresponding plurality of replica or virtual display devices 402′. This process corresponds to the step of “unfolding” an optical path within the waveguide, so that a light ray of a replica is extrapolated back to a “virtual surface” without internal reflection within the waveguide. Thus, the light of the expanded exit pupil may be considered to originate from a virtual surface (also called an “extended modulator” herein) comprising the display device 402 and the replica display devices 402′.

The method of calculating a hologram defines a so-called “extended modulator”, in which the display device (e.g. LCOS SLM) is “extended” by an array of virtual replicas thereof, which would be formed by one or more waveguide pupil expanders, to form an “extended modulator” or “virtual surface” (e.g. as shown in FIG. 4). For example, the display device (e.g. LCOS SLM) may be located at position (0, 0) of the extended modulator shown in FIG. 6, and (virtual) replicas (i.e. replica display devices) that would be formed by two one-dimensional pupil expanders are located at positions extending to (0,2) in a first direction of pupil expansion and (4, 0) in a second direction of pupil expansion. The direction of the optical path is shown by arrow 601, which is perpendicular to the first and second directions of pupil expansion.

Accordingly, an extended modulator is defined comprising: (i) a first offset between replicas generated in a first waveguide pupil expander (e.g. an elongate waveguide) defined by an angle (in space) and corresponding direction of pupil expansion, (ii) a second offset between replicas generated in a second waveguide pupil expander (e.g. planar waveguide) defined by an angle (in space) and corresponding direction of pupil expansion; (iii) any skew between the direction of the first offset and the second offset—creating the general parallelogram shape in FIG. 6, and (iv) the optical path length (difference) between display device replicas and the eye position—in the direction 601 shown in FIG. 6.

### Field of View of a Holographic Projection System

FIG. 7 shows how light from a holographic projector in vehicle (for example, forming part of a head-up display for a vehicle) comprising first and second replicators (such as the first and second replicators 520, 540) is relayed to an eye-box. In particular, a (replicated) holographic wavefront 702 is relayed from a transmission/exit surface 742 of the second replicator 540. FIG. 7 shows a single ray emitted from the exit surface 742. It should be clear that a plurality of rays are emitted from different portions of the exit surface 742 simultaneously. The (replicated) holographic wavefront 702 is relayed to an optical combiner 730 (which, in this example, is a windscreen or windshield of a vehicle). At least a portion of the holographic wavefront 702 is reflected by the optical combiner 730 to an eye-box. A viewing system 710 (which, in this example, is the pupil of a user) is positioned in the eye-box to receive light of the holographic wavefront. A holographic reconstruction is viewable from the eye-box.

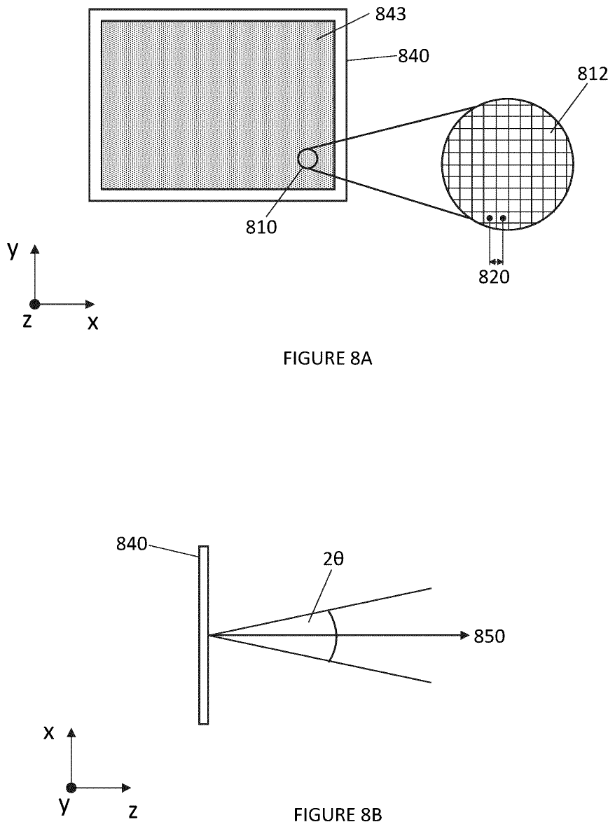

As explained above, the one or more waveguide pupil expanders can be used to address the problem of how to increase the range of angles of light rays that are propagated from the display device that can successfully propagate through an eye's pupil to form an image. In particular, different angular parts of an image are received by the viewing system 710 in the eye-box from different replicas of the extended modulator (see FIGS. 4 and 6). In this way, the viewing system 710 (in the eye-box) receives the full (rather than a partial) field of view of a holographic reconstruction projected by a holographic projection system. However, the one or more waveguide pupil expanders per se do not increase a maximum field of view of the holographic projection system. In other words, the described arrangement of the pupil expander(s) may ensure that the viewing system 710 receives all angular content such that a complete holographic reconstruction of a picture is formed, but the total amount of angular content available is not increased, nor is the full field of view of the holographic reconstruction. For example, the field of view of the holographic reconstruction is dependent on/determined by a diffraction angle of a display device of the holographic projector. In particular, a (maximum) diffraction angle of the display device places an upper limit on the range of angular content received at the eye-box and so a maximum limit on the field of view of the holographic reconstruction. This is explained in more detail in FIGS. 8A an 8B.

FIG. 8A shows a schematic view of an example display device 840 of a holographic projection system. In this example, the display device 840 is a pixelated liquid crystal on silicon (LCoS) spatial light modulator. The display device 840 comprises a display area 842 containing the pixels of the display device in a regular, square, array. A portion 810 of the display device 840 is magnified to more clearly show how individual pixels 812 of the display device 840 are arranged in an array. In this example, each pixel 812 is square. A pixel pitch 820 of the display device 840 is defined as the distance between the respective centres of adjacent pixels 812. Because, in this example, the pixels 812 are square, the pixel pitch 820 is equal in a first (x) direction and second (y) direction that is perpendicular to the x-direction. The (maximum) diffraction angle of the display device 840 is dependent on this pixel pitch. This is described in the following equation:

$$θ = \pm {sin}^{- 1} ( \frac{λ}{2 x} )$$

where θ is the diffraction angle, λ is the wavelength of incident light and x is the pixel pitch 820.

FIG. 8B represents the maximum range of diffraction angles of the display device. The central arrow 850 represents a projection axis of the holographic projection system. In all examples, the field of view of a holographic projection system is fundamentally limited by/dependent on the maximum diffraction angle. For example, the field of view of a holographic projection system may be substantially equal to 2θ. This may be the case when there is no net magnification or demagnification of the holographic wavefront formed by the display device between display device and the eye-box. Even if there is net demagnification or magnification (which, as the skilled reader will appreciate, may scale the field of view to increase or decrease the field of view relative to the maximum diffraction angle) the field of view is still fundamentally dependent on the diffraction angle of the display device 840. This fundamental limit can make it difficult to provide a holographic projection system that can achieve a desired field of view (where this is a general need or desire for a large field of view).

One option to increase the field of view could be to reduce the pixel pitch 820 of the display device. But, as described previously, it is often not possible/efficient to sufficiently decrease the pixel pitch to achieve a desired field of view. For example, it may not be possible to reliably manufacture a display device having a suitable small pixel pitch and, even if it is, doing so may increase the cost and complexity of manufacturing the display device. Furthermore, it is preferable to maintain the replica pitch between replicas of the of extended modulator (without introducing empty spaces between adjacent replicas). The replicas of the extended modulator are replicas of the hologram displayed on the display device 840 and so the size of the replicas corresponds to the size of the display device. So, to maintain the replica pitch, the display device size must be maintained while reducing pixel pitch. Thus, even if it were possible to select a display device having a desirably small pixel pitch, it would be necessary to significantly increase the total number of pixels to ensure that a corresponding total area of the display device 840 is covered by pixels. This increase in the number of pixels is typically not necessary to achieve a good quality holographic reconstruction, but is necessitated by the desired diffraction angle/field of view. Thus, this approach to increasing the field of view can lead to the use of unnecessarily high resolution displays. Another option could to be include a net-demagnification of the holographic wavefront to increase the field of view. However, this then requires the size of the display device to be increased to maintain the replica pitch of the extended modulator. Again, this requires the total number of pixels to be increased (to cover the larger display device) which has similar downsides to those described above.

### Increased Field of View

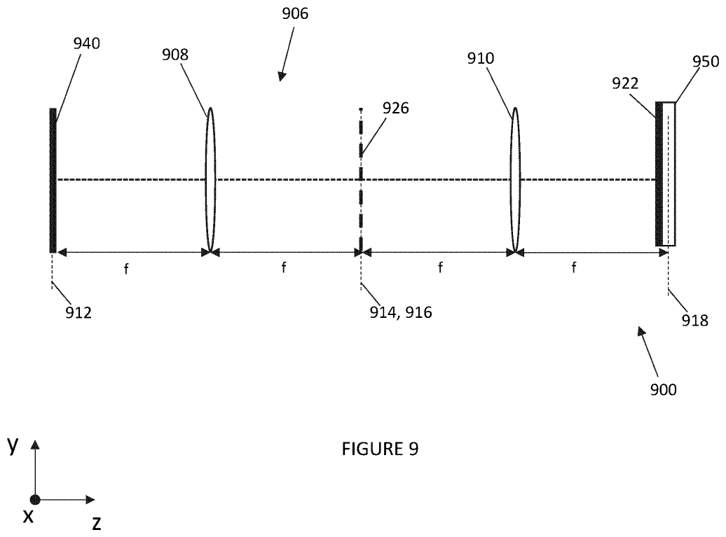

FIG. 9 shows a schematic cross-sectional view of an example of a portion of a holographic projection system 900 according to the present disclosure. The holographic projection system 900 comprises a holographic wavefront redirector 950. The inventors have recognised that the holographic wavefront redirector 950, in combination with a particular hologram calculation method, allows for the field of view of a holographic projection system 900 to be increased. In particular, the unconventional holographic projection system allows the field of view to be increased beyond the normal fundamental limit determined by the maximum diffraction angle of the display device and without the need to implement a net demagnification in the holographic projection system (although, in some examples, the holographic projection system may have a net magnification or demagnification for other reasons, for example as a result of magnification caused by the shape of the optical combiner 730).

In more detail, FIG. 9 shows a display device 940. Downstream of the display device 940 is an optical relay 906. The optical relay 906 comprises a first lens 908 and a second lens 910 downstream of the first lens 908. In this example, the optical power of the first lens 908 is equal to the optical power of the second lens 910. Furthermore, the focal length of the first and second lenses 908, 910 are the same (and are equal to f, as represented by the arrows in FIG. 9). The first lens 908 comprises a front focal plane 912 and a back focal plane 914. The second lens 910 comprises a front focal plane 916 and a back focal plane 918. The back focal plane 914 of the first lens 908 and the front focal plane 916 of the second lens 910 are co-planar. Thus, the optical relay may be referred to as a “4f” system because the distance between the front focal plane 912 of the first lens 908 and the back focal plane 918 of the second lens 910 is equal to four times the focal length, f, of the first and second lens 908,910. The display device 940 is substantially coplanar with the front focal plane 912 of the first lens 908. A holographic wavefront redirector 950 is substantially coplanar with the back focal plane 918 of the second lens 910.

The display device 940 in this example is an LCoS spatial light modulator. The display device 940 is arranged to display a sequence of holograms of a respective sequence of target pictures. The calculation of each hologram will be described below. The display device 940 is arranged to be illuminated by coherent light from a light source (such as laser light of a laser). The display device 940 is arranged to spatially modulate the light incident thereon in accordance with a respective hologram of a respective picture. This forms a holographic wavefront. The holographic projection system 900 is arranged such that the holographic wavefront is relayed/propagated to the optical relay 906 to be received by the first lens 908 and the second lens 910 in turn. The first lens 908 of the optical relay is arranged to form a holographic reconstruction 926. This holographic reconstruction 926 may be formed substantially at the back focal plane 912 of the first lens 908. The second lens 910 is arranged to form a relayed hologram 922 at the back focal plane 918. The relayed hologram 922 corresponds to the display device (comprising the displayed hologram of the picture). In this example, the holographic wavefront redirector 950 (positioned at the back focal plane 918) is arranged to act on/process the holographic wavefront.

The holographic projection system 900 further comprises first and second waveguides downstream of the holographic wavefront redirector 950. These waveguides are not shown in the drawings. However, it should be understood that the processed holographic wavefront is relayed from the holographic wavefront redirector 950 to the first and second waveguides where the holographic wavefront is replicated to form an extended modulator, as described previously. After replication, the holographic projection system 900 is arranged such that the replicated holographic wavefront is relayed to an optical combiner (e.g. windshield or windscreen). At least a portion of the intensity of the holographic wavefront is reflected/relayed by the optical combiner to an eye-box.

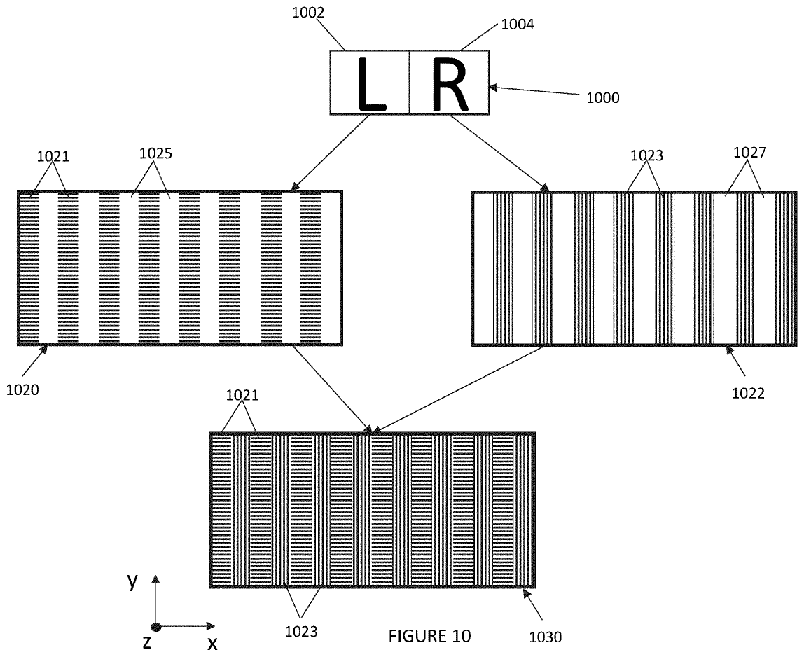

FIG. 10 schematically represents the calculation of a hologram for projection by the holographic projection system 900. In this example, the steps of this calculation are performed by a hologram engine of the holographic projection system 900, not specifically shown in the drawings.

FIG. 10 shows a target picture 1000. This is the picture that is intended to be viewable/holographically reconstructed at the eye-box of the holographic projection system 900. The target picture 1000 comprises a left field of view 1002 (represented by the letter “L” in FIG. 10) and a right field of view 1004 (represented by the letter “R” in FIG. 10).

A first step performed by the hologram engine is to receive the target picture 1000. A second step performed by the hologram engine is to divide the target picture into a first (left) portion comprising the left field of view 1002 and a second (right) portion comprising the right field of view 1004. A third step performed by the hologram engine is to calculate a first sub-hologram 1020 of the left field of view 1002 of the (divided) target picture and a second sub-hologram 1022 of the right field of view 1004 of the (divided) target picture. In this example, the hologram engine is arranged to calculate the first sub-hologram such that it is separated into or comprises a plurality of first strips 1021. Each first strip 1021 comprises diffractive or hologram content. Between each first strip 1021 is an empty strip 1025 of non-hologram or non-diffractive content. The hologram engine is further arranged to calculate the second sub-hologram such that it is separated into or comprises a plurality of second strips 1023. Each second strip 1023 comprises diffractive or hologram content. Between each first strip 1023 is an empty strip 1027 of non-hologram or non-diffractive content. A fourth step performed by the hologram engine is to spatially interlace the first and second sub-holograms 1020, 1022 to form a hologram 1030. The hologram 1030 comprises first strips 1023 (of the first sub-hologram 1020) and second strips 1025 (of the second sub-hologram 1022) in an alternating configuration. In particular, the hologram engine is arranged such that each empty strip 1025 (of the first sub-hologram 1020) is filled with a respective second strip 1025 of the second sub-hologram 1022 and such that each empty strip 1027 of the second sub-hologram 1022 is filled with a respective first strip 1023 of the first hologram 1020. In other words, in this example, the spatial interlacing effectively comprises superimposing the first and second sub-holograms 1020,1022. In this example, each first and second strip 1023, 1027 has a width (in the x direction) of 0.5 mm. The hologram engine is further arranged to output the hologram 1030 to the display device 940. The holographic projection system 900 is arranged such that the display device 940 is driven to display the hologram 1030.

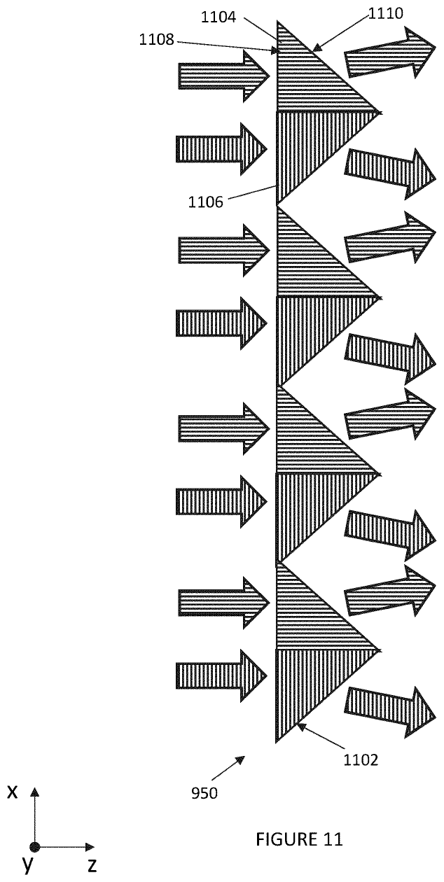

FIG. 11 shows a cross-sectional view of the holographic wavefront redirector 950 in an x-z plane. In this example, the holographic wavefront redirector 950 comprises an array of prisms 1102. Each prism of the array of prisms 1102 is formed of a transparent material having a refractive index greater than 1. The array of prisms 1102 comprises a first subset of prisms 1104 and a second subset of prisms 1106. Each prism of the first subset of prisms 1104 is represented by vertical shading in FIG. 11. Each prism of the first subset of prisms 1104 may be said to form a first redirection zone. Each prism of the second subset of prisms 1106 is represented by horizontal shading in FIG. 11. Each prism of the second subset of prims 1106 may be said to form a second redirection zone. Each prism of the array of prisms 1102 comprises an input surface 1108 arranged to receive light and an output surface 1110 (substantially opposite to the input surface 1108) arranged to output light that has been deflected relative to the light received at the input surface. Specifically, each prism of the first subset of prism 1104/each first redirection zone is arranged to deflect received light at a first deflection angle with respect to the z-axis shown in FIG. 9. Each prism of the second subset of prisms 1106/each second redirection zone is arranged to deflect received light at a second deflection angle with respect to the z-axis. In this example, the first and second deflection angles are equal in magnitude but opposite in the direction. Each deflection angle is solely within the x-z plane. The first deflection angle is in the counter-clockwise direction (as viewed in FIG. 9) and the second deflection angle is in the clockwise direction. In FIG. 9, light that is incident on, and processed by (deflected by), the first subset of prisms 1104 is vertically shaded. Light that is incident on, and processed by (deflected by), the second subset of prisms 1106 is horizontally shaded.

As described above, the holographic wavefront redirector 950 is coplanar with the back focal plane 918 of the second lens 910 of the optical relay 906. It may be said that the holographic wavefront forms the relayed hologram 922 substantially at this position. The relayed hologram 922 substantially corresponds to the hologram that is displayed on the display device 940. So, when the hologram 1030 is displayed on the display device, the relayed hologram 922 has a corresponding striped appearance comprising strips 1023 of a first sub-hologram spatially interlaced with strips 1027 of a second sub-hologram such that the strips 1023, 1027 are in an alternating configuration. The array of prisms 1102 of the holographic wavefront redirector 950 are arranged such that the input surface of each prism of the first sub-set of prisms 1104 is optically coupled to a (first) strip 1021 of the first sub-hologram (of the relayed hologram) and such that the input surface of each prism of the second sub-set of prisms 1106 is optically coupled to a (second) strip 1125 of the second sub-hologram (of the relayed hologram). In other words, light of the holographic wavefront that is spatially modulated in accordance with the first sub-hologram is received or receivable by the first sub-set of prisms 1104 and light that is spatially modulated in accordance with the second sub-hologram is received or receivable by the second sub-set of prisms 1106. Because of the position of the holographic wavefront redirector 950 within the system, the light associated with the different sub-holograms may be substantially spatially separated into the respective first and second strips which may not substantially overlap (at the back focal plane 918). Thus, at this position, it possible for the holographic wavefront redirector 950 to process/deflect light associated with the different sub-holograms differently. In particular, light associated with the first sub-hologram is deflected by the first deflection angle and light associated with the second sub-hologram is deflected by the second deflection angle.

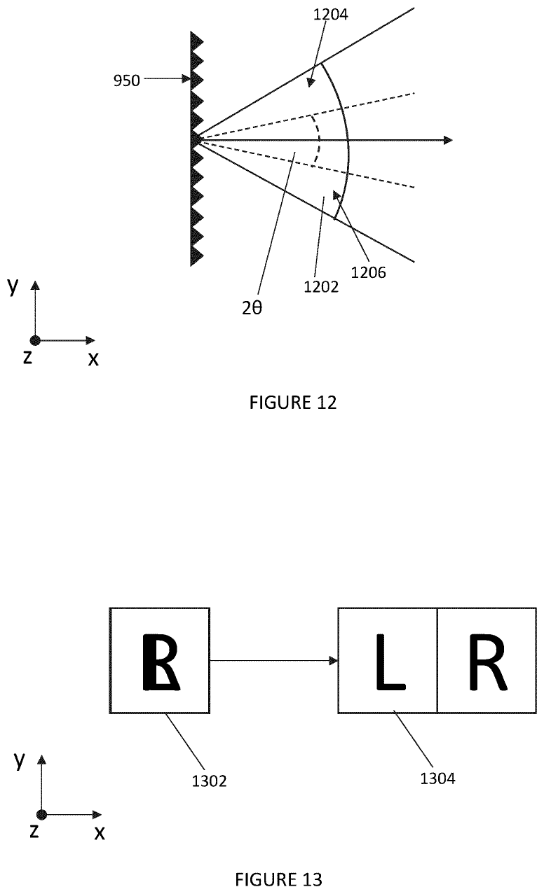

The effect of the holographic wavefront redirector 950 (in combination with the “striped” hologram) is to increase the field of view of the holographic projection system 900. In some examples, the holographic wavefront redirector 950 is able to double the field of view of the holographic projection system 900 (compared to a corresponding holographic projection system in the absence of the redirector 950). Thus, the field of view of can increased beyond the (maximum) diffraction angle of the display device 950 (e.g. the field of view can be increased to double the maximum diffraction angle of the display device 950). This is explained in relation to FIG. 12.

FIG. 12 is a schematic cross-sectional view of the holographic wavefront redirector 950 in the x-z plane. The solid lines of FIG. 12 represent the range of angles 1202 that light is emitted from the holographic wavefront redirector 950 after a first portion of the holographic wavefront has been deflected by the first deflection angle and a second portion of the holographic wavefront has been deflected by the second deflection angle (as described above). A first sub-range 1204 of the angles predominantly comprises light of the first sub-hologram. A second sub-range 1206 of the angles predominantly comprises light of the second sub-hologram. The dotted lines of FIG. 12 represents the (maximum) diffraction angle of the display device 950. FIG. 12 shows how the range of angles 1202 has been substantially increased relative to the diffraction angle 20 of the display device 950. Specifically, both the first sub-range 1204 of angles are substantially equal to the maximum diffraction angle of the display device 950 such that the holographic wavefront redirector 950 has doubled the range of angles over which light is emitted. This has the effect of increasing (e.g. doubling) the field of view of the holographic projection system 900.

FIG. 13 schematically represents the effect of the holographic wavefront redirector 950 on the holographic reconstruction formed by the holographic projection system 900 (and the field of view of the system 900).

The left of FIG. 13 is a representation 1302 of the holographic reconstruction 926 formed by the first lens 908 at the back focal plane 914. At this point, the field of view of the holographic reconstruction 926 depends entirely on the display device 950 (specifically, the pixel pitch of the display device 950) and the wavelength of light incident thereon. For example, the field of view of the holographic reconstruction 926 may be 6 degrees. The hologram 1030 has been calculated to compensate for the presence of the holographic wavefront redirector 950. As such, at the (intermediate) holographic reconstruction 926, the reconstruction of the left field of view 1002 of the target picture overlaps the right field of view 1004 of the target picture. As such, in the representation 1302 of FIG. 13, the “L” and the “R” overlap. In other words, the 6 degree field of view of the holographic reconstruction 926 is filled with an overlapping reconstruction of the left and right field of view 1002, 1004 of the target picture.

The right of FIG. 13 is a representation 1304 of a holographic reconstruction of the target picture viewable from the eye-box of the system 900 (i.e. after the holographic wavefront has been processed by the holographic wavefront redirector). At this point, the holographic wavefront redirector has redirected suitable portions of the holographic wavefront such that the holographic reconstruction of the left field of view 1002 is adjacent to the holographic reconstruction of the right field of view 1004. Each reconstruction occupies/fills a 6 degree field of view such that the total field of view of the holographic reconstruction viewable at the eye-box has been expanded/increased/doubled by the holographic wavefront redirector to 12 degrees

The inventors have recognised that the spatial interlacing of the first and second sub-holograms is an important aspect of realizing the field of view increase (beyond the diffraction angle of the display device 950). Different sub-sets of zones of the holographic wavefront redirector deflect light at different angles. Thus, not all zones/areas on the holographic wavefront redirector emit light of all angles. This could result in dark bands in the holographic reconstruction if the viewing system/user does not receive all angular content at a particular eye-box position. The inventors have recognised that the spatial interlacing significantly reduces the risk of dark bands. The inventors have found that spatially interlacing strips of sub-holograms having a width that is so small that the viewing system is not able to distinguish individual strips (e.g. from 1 metre) may be particularly effective at minimizing/eliminating the darks bands and any other associated artefacts which may be visible to the naked eye. To the viewing system/eye, it may appear that all angular content is emitted from all zones of the holographic wavefront redirector.

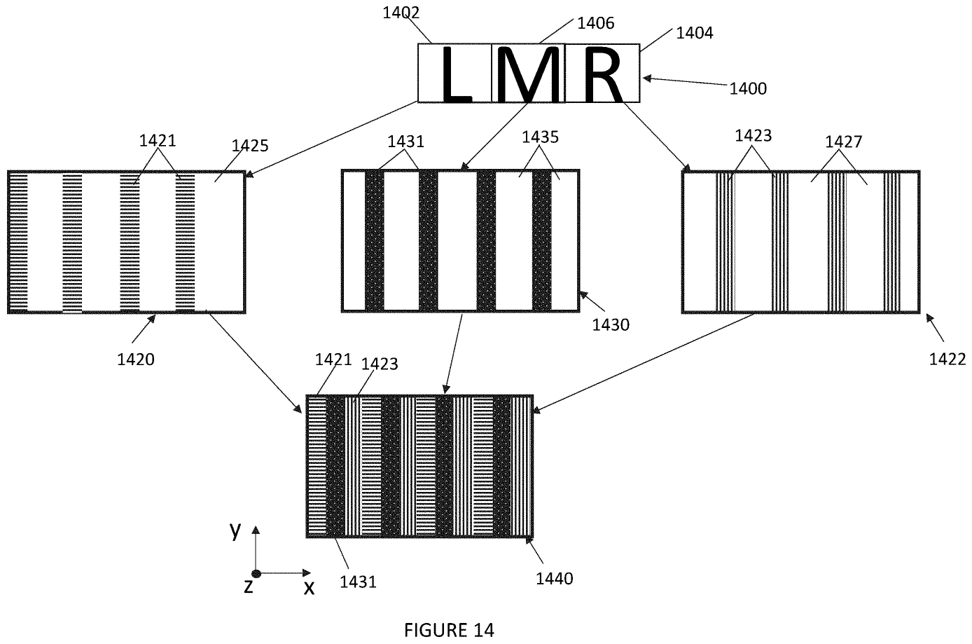

In the above described example, a target picture is split into two portions 1002, 1004. Two sub-holograms are calculated and spatially interlaced to form the hologram 1030. The holographic wavefront redirector comprises two corresponding subsets of prisms/redirection zones. However, it should be clear to the skilled reader that this is merely exemplary. In particular, the target picture could be split into more than two portions (e.g. three portions). A corresponding number of sub-holograms would be calculated and spatially interlaced (e.g. three sub-holograms). A holographic wavefront redirector would be provided with a corresponding number of sub-sets of prisms/redirection zones for the number of sub-holograms, each subset being arranged to deflect light at a different discrete angle (e.g. three sub-sets and three different deflection angles). The skilled reader will appreciate that, in examples in which the target picture is split into more than two portions, the field of view can be increased even more than in the above described example. For example, if the target picture is split into three portions, the field of view of the system may be tripled. This is shown in FIG. 14.

FIG. 14 shows a target picture 1400. This is the picture that is intended to be viewable/holographically reconstructed at the eye-box of the holographic projection system 900. The target picture 1400 comprises a left field of view 1402 (represented by the letter “L” in FIG. 14), a right field of view 1404 (represented by the letter “R” in FIG. 14), and a middle field of view 1406 (represented by the letter “M” in FIG. 14) between the left and right fields of view 1402, 1404.

A first step performed by the hologram engine is to receive the target picture 1400. A second step performed by the hologram engine is to divide the target picture into the first (left) portion comprising the left field of view 1402, the second (right) portion comprising the right field of view 1404 and the middle portion comprising the middle field of view 1406. A third step performed by the hologram engine is to calculate a first sub-hologram 1420 of the left field of view 1402 of the (divided) target picture, a second sub-hologram 1422 of the right field of view 1404 of the (divided) target picture and a third sub-hologram 1430 of the middle field of view 1406 of the (divided) target picture. In this example, the hologram engine is arranged to calculate the first sub-hologram such that it is separated into or comprises a plurality of first strips 1421. Each first strip 1421 comprises diffractive or hologram content. Between each first strip 1421 is an empty strip 1425 of non-hologram or non-diffractive content. The hologram engine is further arranged to calculate the second sub-hologram 1422 such that it is separated into or comprises a plurality of second strips 1423. Each second strip 1423 comprises diffractive or hologram content. Between each first strip 1423 is an empty strip 1427 of non-hologram or non-diffractive content. The hologram engine is further arranged to calculate the third sub-hologram 1430 such that it is separated into or comprises a plurality of third strips 1431. Each third strip 1431 comprises diffractive or hologram content. Between each third strip 1431 is an empty strip 1435 of non-hologram or non-diffractive content. Compared to the example of FIG. 10, in FIG. 14 the empty strips 1425, 1427, 1435 are relatively wider (in particular, are double the width of the corresponding empty strips of FIG. 10 and double the width of the first, second and third strips 1421, 1423, 1431 of diffractive content). This allows for the spatial interlacing of three sub-holograms (rather than two). A fourth step performed by the hologram engine is to spatially interlace the first, second and third sub-holograms 1420, 1422, 1430 to form a hologram 1440. The hologram 1440 comprises first strips 1421 (of the first sub-hologram 1420), second strips 1423 (of the second sub-hologram 1422) and third strips 1431 (of the third sub-hologram 1430) in an alternating configuration. In particular, the hologram engine is arranged such that each empty strip 1425 (of the first sub-hologram 1420) is filled with a respective second strip 1423 of the second sub-hologram 1422 and a respective third strip 1431 of the third sub-hologram 1430. The other empty strips 1435 and 1427 are similarly filled with diffractive content/strips of the other sub-holograms. In other words, in this example, the spatial interlacing effectively comprises superimposing the first, second and third sub-holograms 1420, 1422, 1430. In this example, each first, second and third strip 1421, 1423, 1431 has a width (in the x direction) of 0.5 mm. The hologram engine is further arranged to output the hologram 1440 to the display device 940. The holographic projection system 900 is arranged such that the display device 940 is driven to display the hologram 1440.

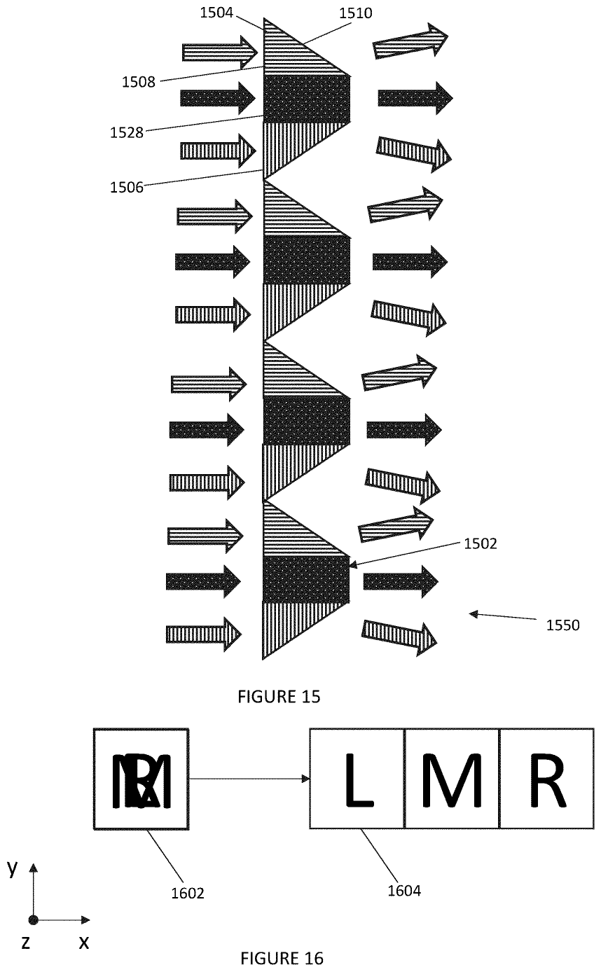

FIG. 15 shows a cross-sectional view of a second example of a holographic wavefront redirector 1550 in an x-z plane for use with the hologram 1440 of FIG. 14. In this example, the holographic wavefront redirector 1550 comprises an array of prisms 1502. Each prism of the array of prisms 1502 is formed of a transparent material having a refractive index greater than 1. The array of prisms 1502 comprises a first subset of prisms 1504, a second subset of prisms 1506 and a third subset of prisms 1528. Each prism of the first subset of prisms 1504 is represented by vertical shading in FIG. 15. Each prism of the first subset of prisms 1504 may be said to form a first redirection zone. Each prism of the second subset of prisms 1506 is represented by horizontal shading in FIG. 15. Each prism of the second subset of prims 1506 may be said to form a second redirection zone. Each prism of the third subset of prisms 1528 is represented by solid dark shading comprising white dots in FIG. 15. Each prism of the third subset of prims 1506 may be said to form a third redirection zone. Each prism of the array of prisms 1502 comprises an input surface 1508 arranged to receive light and an output surface 1510 (substantially opposite to the input surface 1508) arranged to output light that has been deflected relative to the light received at the input surface. Specifically, each prism of the first subset of prism 1504/each first redirection zone is arranged to deflect received light at a first deflection angle with respect to the z-axis. Each prism of the second subset of prisms 1506/each second redirection zone is arranged to deflect received light at a second deflection angle with respect to the z-axis. Each prism of the third subset of prisms 1528/each third redirection zone is arranged to deflect received light at a third deflection angle with respect to the z-axis. In this example, the first and second deflection angles are equal in magnitude but opposite in the direction. The third deflection angle is equal to zero. So, each of the three deflection angles are different. Each deflection angle is solely within the x-z plane. The first deflection angle is in the counter-clockwise direction (as viewed in FIG. 15) and the second deflection angle is in the clockwise direction. In FIG. 15, light that is incident on, and processed by (deflected by), the first subset of prisms 1504 is vertically shaded. Light that is incident on, and processed by (deflected by), the second subset of prisms 1506 is horizontally shaded. Light that is incident on, and processed by (deflected by), the third subset of prisms 1528 comprises solid dark shading comprising white dots.

Similarly to the holographic wavefront redirector 950, when the holographic wavefront redirector 1550 is part of a holographic projection system (such as the system shown in FIG. 9), it is coplanar with the back focal plane 918 of the second lens 910 of the optical relay 906. It may be said that the holographic wavefront forms the relayed hologram 922 substantially at this position. The relayed hologram 922 substantially corresponds to the hologram that is displayed on the display device 940. So, when the hologram 1440 is displayed on the display device, the relayed hologram has a corresponding striped appearance comprising strips 1421 of a first sub-hologram spatially interlaced with strips 1423 of a second sub-hologram and strips 1431 of a third sub-hologram such that the strips 1421, 1423, 1431 are in an alternating configuration. The array of prisms 1502 of the holographic wavefront redirector 1550 are arranged such that the input surface of each prism of the first sub-set of prisms 1504 is optically coupled to a (first) strip 1421 of the first sub-hologram (of the relayed hologram); such that the input surface of each prism of the second sub-set of prisms 1506 is optically coupled to a (second) strip 1423 of the second sub-hologram (of the relayed hologram); and such that the input surface of each prism of the third sub-set of prisms 1528 is optically coupled to a (third) strip 1431 of the third sub-hologram (of the relayed hologram). In other words, light of the holographic wavefront that is spatially modulated in accordance with the first sub-hologram is received or receivable by the first sub-set of prisms 1504; light that is spatially modulated in accordance with the second sub-hologram is received or receivable by the second sub-set of prisms 1506; and light that is spatially modulated in accordance with the third sub-hologram is received or receivable by the third sub-set of prisms 1528. Because of the position of the holographic wavefront redirector 1550 within the system, the light associated with the different sub-holograms may be substantially spatially separated into the respective first and second strips which may not substantially overlap (at the back focal plane 918). Thus, at this position, it possible for the holographic wavefront redirector 1550 to process/deflect light associated with the different sub-holograms differently. In particular, light associated with the first sub-hologram is deflected by the first deflection angle; light associated with the second sub-hologram is deflected by the second deflection angle; and light associated with the third sub-hologram is deflected by the third deflection angle (as represented in FIG. 15).

The effect of the holographic wavefront redirector 1550 (in combination with the “striped” hologram 1440) is to increase the field of view of the holographic projection system 900. In some examples, the holographic wavefront redirector 1550 is able to triple the field of view of the holographic projection system 900 (compared to a corresponding holographic projection system in the absence of the redirector 1550). Thus, the field of view of can increased beyond the (maximum) diffraction angle of the display device 1550 (e.g. the field of view can be increased to triple the maximum diffraction angle of the display device 950).

FIG. 16 schematically represents the effect of the holographic wavefront redirector 1550 on the holographic reconstruction formed by the holographic projection system 900 (and the field of view of the system 900).

The left of FIG. 16 is a representation 1602 of the holographic reconstruction formed by the first lens 908 at the back focal plane 914 when hologram 1440 is displayed on the display device 940 of the system. At this point, the field of view of the holographic reconstruction depends on the display device 950 (specifically, the pixel pitch of the display device 950) and the wavelength of light incident thereon. For example, the field of view of the holographic reconstruction 926 may be 6 degrees. The hologram 1440 has been calculated to compensate for the presence of the holographic wavefront redirector 1550. As such, at the (intermediate) holographic reconstruction 926, the reconstruction of the left field of view 1402 of the target picture overlaps the right field of view 1404 of the target picture and the middle field of view 1406 of the target picture. As such, in the representation 1602 of FIG. 16, the “L”, the “R” and the “M” overlap. In other words, the 6 degree field of view of the holographic reconstruction 926 is filled with an overlapping reconstruction of the left, right and middle fields of view 1402, 1404, 1406 of the target picture.

The right of FIG. 16 is a representation 1604 of a holographic reconstruction of the target picture viewable from the eye-box of the system 900 (i.e. after the holographic wavefront has been processed by the holographic wavefront redirector 1550). At this point, the holographic wavefront redirector has redirected suitable portions of the holographic wavefront such that the holographic reconstruction of the left field of view 1402 is adjacent to the holographic reconstruction of the middle field of view 1406, which in turn is adjacent to the right field of view 1404. Each reconstruction occupies/fills a 6 degree field of view such that the total field of view of the holographic reconstruction viewable at the eye-box has been expanded/increased/triple by the holographic wavefront redirector to 18 degrees.

### Random or Irregular Spatial Interlacing

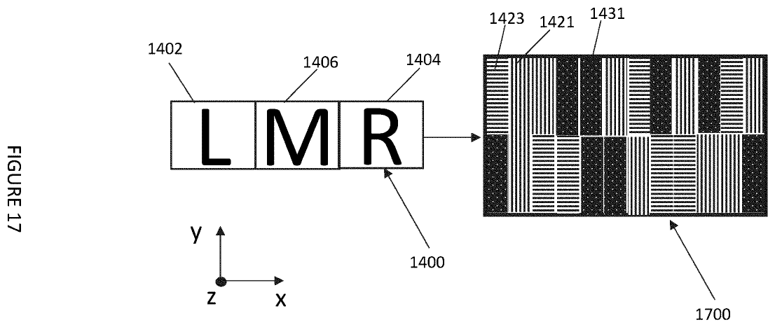

In the example(s) described above, the holograms 1030, 1440 are formed by spatially interlacing sub-holograms in a regular fashion such that the holograms 1030, 1440 comprises strips of the constitute sub-holograms in a periodic, alternating and regular pattern. However, in embodiments according to the present disclosure, the spatial interlacing may instead be randomised or irregular. This is shown in FIG. 17.

On the left side of FIG. 17 is the same target picture 1400 as in FIG. 14 (comprising a left “L” field of view 1402, a right “R” field of view 1404 and a middle “M” field of view of view 1406 between the left and right fields of view. On the right side of FIG. 17 is a hologram 1700 of the target picture 1400 formed when the hologram engine is arranged to spatially interlace first, second and third sub-holograms of the left, right and middle fields of view 1402, 1404, 1406 in a random or irregular manner. The hologram (or composite hologram) 1700 comprises a sequence of discrete portions or strips of the first, second and third sub-holograms randomly ordered based on the respective sub-hologram of the strips. As in the example of FIG. 14, strips or portions 1421 of the first sub-hologram of the left field of view 1402 comprises shading with horizontal strips, strips or portions 1423 of the second sub-hologram of the right field of view 1404 comprises shading with vertical strips, and strips or portions 1431 of the third sub-hologram of the middle field of view 1406 comprises solid dark shading with white dots.

In more detail, the hologram engine is arranged to form the composite hologram 1700 by performing the following steps. A first step performed by the hologram engine is to receive the target picture 1400. A second step performed by the hologram engine is to divide the target picture into the first (left) portion comprising the left field of view 1402, the second (right) portion comprising the right field of view 1404 and the middle portion comprising the middle field of view 1406. A third step performed by the hologram engine is to calculate a first sub-hologram of the left field of view 1402 of the (divided) target picture, a second sub-hologram of the right field of view 1404 of the (divided) target picture and a third sub-hologram of the middle field of view 1406 of the (divided) target picture. A fourth step performed by the hologram engine is to randomly spatially interlace the first, second and third sub-holograms 1 to form the hologram 1700.

In this example, the hologram engine spatially interlaces the hologram 1700 by sequentially building the hologram 1700 portion-by-portion. In particular, for each discrete portion of the hologram 1700, the hologram engine is arranged to randomly select one of the plurality of sub-holograms (e.g. randomly select the first, second or third sub-hologram). The hologram engine is then arranged to identify a portion of the selected (e.g. first, second or third) sub-hologram. In this example, the hologram engine is arranged to identify a portion of the selected sub-hologram that has not previously been selected. For example, at the start of the spatial interlacing process, the hologram engine is arranged to divide each sub-hologram into a plurality of pre-determined portions equal in width to the desired width of the individual portions of the formed composite hologram 1700. The hologram engine may be arranged such that, each time a sub-hologram is randomly selected, a pre-determined portion of the sub-hologram is identified that has not previously been identified (e.g. the hologram engine may be arranged to work from left to right of each of the sub-holograms). For each iteration, the hologram engine is arranged such that the identified portion of the selected sub-hologram forms the respective discrete portion of the hologram 1700. As the skilled reader will appreciate, the hologram engine performing such a method results in a hologram 1700 being constructed in which strips or portions of the three sub-holograms have been connected or concatenated randomly such that the hologram 1700 comprises a random sequence (arrangement/pattern) of portions of the sub-holograms. In some examples, the hologram engine is arranged such that the step of randomly selecting one of the plurality of sub-holograms has some constraints in place to prevent the same sub-hologram being selected consecutively a repeated number of times. For example, the hologram engine may be arranged such that the same sub-hologram can be selected no more than twice in a row. This may prevent the hologram 1700 being formed relatively large (wide) areas consisting of the same sub-hologram.

In other examples, the random sequence of the discrete portions of sub-hologram used to form the composite hologram 1700 is predetermined. For example, such a random sequence may be pre-programmed into the hologram engine (e.g. stored in a memory of the hologram engine). The hologram engine may then form the hologram 1700 by piecing together/connecting portions of the sub-holograms in the order determined by the pre-determined sequence.

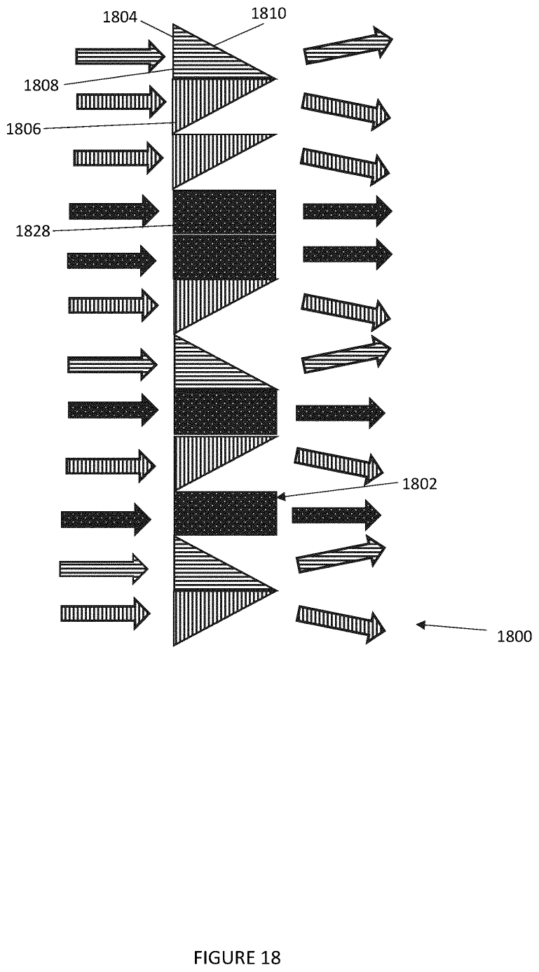

The redirection zones of wavefront redirector (e.g. holographic wavefront redirector) used in combination with a hologram 1700 formed by randomly spatially interlacing sub-holograms need to reflect the random sequence of the strips/portions forming the hologram 1700. Such a holographic wavefront redirector 1800 is shown in FIG. 18.

FIG. 18 shows a cross-sectional view of a third example of a holographic wavefront redirector 1800 in an x-z plane for use with the hologram 1700 of FIG. 17. As in previous example of the holographic wavefront redirector, the holographic wavefront redirector 1800 comprises an array of prisms 1802 formed of a transparent material having a refractive index greater than 1. The array of prisms 1802 comprises a first subset of prisms 1804, a second subset of prisms 1806 and a third subset of prisms 1828. The prisms in each subset form, respectively, first, second and third redirection zones. Prisms in the different subsets are arranged to deflect received light (at an input surface) at different respective deflection angles such that there is a first deflection angle (with respect to a z-axis) associated with each of the first subset of prisms, a second deflection angle (with respect to the z-axis) associated with each of the second subset of prisms, and a third deflection angle (with respect to the z-axis) associated with each of the third subset of prisms. In this example, the first and second deflection angles are equal in magnitude but opposite in the direction. The third deflection angle is equal to zero. The redirection zones/prisms of the holographic wavefront redirector 1800 have a corresponding pattern/sequence to that of hologram 1700. This ensures that, despite the random spatial interlacing of the sub-holograms to form hologram 1700, the array of prisms 1802 of the holographic wavefront redirector 1800 are arranged such that the input surface of each prism of the first sub-set of prisms 1802 is optically coupled to a (first) strip 1721 of the first sub-hologram (of the relayed hologram); such that the input surface of each prism of the second sub-set of prisms 1806 is optically coupled to a (second) strip 1725 of the second sub-hologram (of the relayed hologram); and such that the input surface of each prism of the third sub-set of prisms 1828 is optically coupled to a (third) strip 1731. Thus, light of the holographic wavefront that is spatially modulated in accordance with the first sub-hologram is received or receivable by the first sub-set of prisms 1804; light that is spatially modulated in accordance with the second sub-hologram is received or receivable by the second sub-set of prisms 1806; and light that is spatially modulated in accordance with the third sub-hologram is received or receivable by the third sub-set of prisms 1828. Because of the position of the holographic wavefront redirector 1800 within the system, the light associated with the different sub-holograms may be substantially spatially separated into the respective first and second strips which may not substantially overlap (at the back focal plane 918). Thus, at this position, it possible for the holographic wavefront redirector 1800 to process/deflect light associated with the different sub-holograms differently. In particular, light associated with the first sub-hologram is deflected by the first deflection angle; light associated with the second sub-hologram is deflected by the second deflection angle; and light associated with the third sub-hologram is deflected by the third deflection angle (as represented in FIG. 18). This results in the field of view of the system being tripled by the holographic wavefront redirector (in this example). It should be noted that the composite hologram 1700 effectively comprises a two dimensional array of portions of the sub-holograms (having a height of two “portions” in the y direction and a width of twelve “portions” in the x direction). Only a single layer of prisms is shown in FIG. 18, having a pattern or sequence corresponding to the sequence of the top layer of portions of sub-holograms of composite hologram 1700. However, the holographic wavefront redirector 1800 would comprise a further layer (or layers) of prisms having a sequence or pattern corresponding to the sequence or pattern of the second layer (or any further layers) of the hologram.

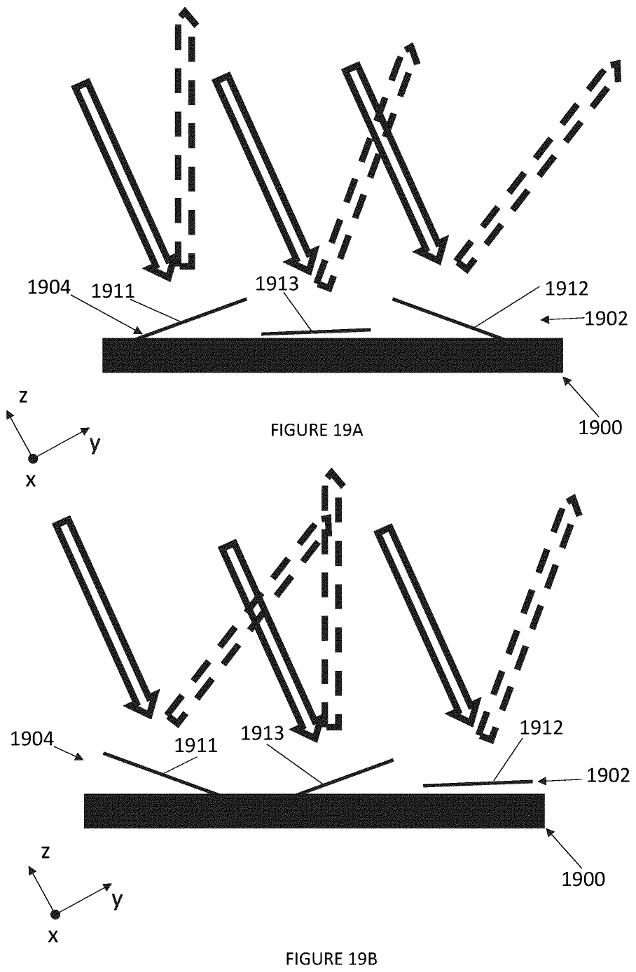

The holographic wavefront redirector 1800 of FIG. 18 may be permanent (i.e. the order of the zones of the holographic wavefront redirector 1800) may be fixed. This may be particularly suitable for examples in which a predetermined/pre-programmed random sequence is stored in a memory of the hologram engine. In such cases, holographic wavefront redirector 1800 is (permanently) arranged such that the order of the redirection zones (formed by prisms of the different subsets) follows the predetermined sequence. However, in examples in which the random sequence is not predetermined, the holographic wavefront redirector is preferably active/dynamic. The holographic wavefront redirector being active/dynamic means that the holographic wavefront redirector can be driven to be reconfigured such that the order of the zones matches the order of the discrete portions of sub-hologram forming the (composite) hologram. In particular, in such a holographic wavefront redirector, each zone may be independently reconfigurable to be suitable for providing each of the desired deflection angles at different times. The skilled reader will be familiar optical components suitable for providing such an active/dynamic holographic wavefront redirector. For example, such a holographic wavefront redirector could comprise a digital micromirror device (DMD) or a liquid crystal device. Such devices may comprise a plurality or array of individual optical components (e.g. micromirrors or liquid crystal cells, respectively), each of which is independently drivable between a plurality of different states or configurations. In each state or configuration, each individual optical component is arranged to provide a different deflection angle. This is explained in more detail below in relation to FIGS. 19A and 19B.

FIGS. 19A and 19B show a portion of a fourth example of a holographic wavefront redirector 1900 comprising a DMD 1902. FIG. 19A shows the DMD 1902 in a first configuration and FIG. 19B shows the DMD 1902 in a second configuration.

The DMD 1902 comprises an array of micromirrors 1904. In this example, each micromirror 1904 is drivable between a first state in which light is deflected by a first deflection angle with respect to the z axis, a second state in which light is deflected by a second deflection angle with respect to the z axis, and a third state in which light is deflected by a third angle deflection angle with respect to the z axis.

In FIG. 19A, a first micromirror 1911 is in the first state, a second micromirror 1912 is in the second state and a third micromirror 1913 is in a third state. FIG. 19A shows how parallel incident light (represented by the unbroken lines) is reflected/deflected at a different angle off each of the first to third micromirrors. The skilled reader will appreciate how the DMD 1902 can be used to selectively deflect light associated with different sub-holograms of a composite hologram (or relayed composite hologram) by different angles. For example, a first subset of micromirrors 1904 in the first state forms first redirection zones of the holographic wavefront redirector 1900 that are optically coupled to a first sub-hologram, a second subset of micromirrors 1904 in the second state forms second redirection zones of the holographic wavefront redirector 1900 that are optically coupled to a second sub-hologram, and a third subset of micromirrors 1904 in the third state forms third redirection zones of the holographic wavefront redirector 1900 that are optically coupled to a third sub-hologram. The deflected/reflected light by each of the micromirrors is represented by the broken arrows in FIG. 19A. The broken arrows show how the deflection angle is different for each of the different states of the micromirrors.

In FIGS. 19A and 19B, only three micromirrors 1904 are shown. However, the skilled reader will appreciate that the DMD 1902 may comprise as many micromirrors as necessary to suitably process a holographic wavefront. A difference between the fourth example holographic wavefront redirector 1900 and the previous examples, is that the holographic wavefront redirector 1900 is reflective whereas the holographic wavefront redirectors are transmissive. The skilled reader will appreciate that this difference will result in a “fold” of the optical path of the holographic system (and corresponding repositioning of optical components of the system), but otherwise does not significantly affect the functionality of the holographic projection system.

In the second configuration of the DMD 1902 shown in FIG. 19B, the three micromirrors 1911 to 1913 have each been driven into different optical states. In particular, in this example, the first micromirror 1911 has been driven into the second state, the second micromirror 1912 has been driven into the first state, and the third micromirror 1913 has been driven into the third state. The skilled reader will appreciate that the DMD 1902 in the second configuration is suitable for a hologram having a different random sequence of discrete portions of sub-holograms compared to the DMD 1902 of the first configuration. In some examples, the DMD 1902 can be driven to have configurations in which a different number of states of the micromirrors are utilised. For example, in the configurations of both FIGS. 19A and 19B, three states are utilised. However, the DMD 1902 can be driven into a configuration in which only two states are used (e.g. the first state and the second state but not the third state). This is not shown in the figures. In this way, the holographic wavefront redirector 1900 can be configured to be suitable for a hologram comprising two or three sub-holograms. For example, when only two states are used, the holographic wavefront redirector 1900 may be suitable for use in a holographic projection system in which hologram 1030 (of FIG. 10) is displayed. In this way, the active holographic wavefront redirector 1900 can dynamically switch between different configurations in which the field of view of the system is increased by different amounts (e.g. a first configuration in which the field of view the system is doubled by the holographic wavefront redirector 1900 and a second configuration in which the field of view of the system is tripled by the holographic wavefront redirector).

In the above described example, the holographic wavefront redirector comprises an array of prisms to deflect light based on refraction. The skilled reader should appreciate that this is merely an example and there are other options for providing different zones on an optical component that deflect incident light at different angles. For example, the deflection could be achieved diffractively. For example, the holographic wavefront redirector may comprise a diffractive optical element (DOE). In some examples, the holographic wavefront redirector may comprise a plurality of diffraction gratings.

In the above described example, the holographic wavefront redirector is positioned so as to processed the relayed hologram. However, the skilled reader should appreciate that this is merely an example and that the holographic wavefront redirector could instead be positioned at/adjacent to the display device or even be provided as a feature of the display device.

### ADDITIONAL FEATURES

The methods and processes described herein may be embodied on a computer-readable medium. The term “computer-readable medium” includes a medium arranged to store data temporarily or permanently such as random-access memory (RAM), read-only memory (ROM), buffer memory, flash memory, and cache memory. The term “computer-readable medium” shall also be taken to include any medium, or combination of multiple media, that is capable of storing instructions for execution by a machine such that the instructions, when executed by one or more processors, cause the machine to perform any one or more of the methodologies described herein, in whole or in part.

The term “computer-readable medium” also encompasses cloud-based storage systems. The term “computer-readable medium” includes, but is not limited to, one or more tangible and non-transitory data repositories (e.g., data volumes) in the example form of a solid-state memory chip, an optical disc, a magnetic disc, or any suitable combination thereof. In some example embodiments, the instructions for execution may be communicated by a carrier medium. Examples of such a carrier medium include a transient medium (e.g., a propagating signal that communicates instructions).

It will be apparent to those skilled in the art that various modifications and variations can be made without departing from the scope of the appended claims. The present disclosure covers all modifications and variations within the scope of the appended claims and their equivalents.

1. A hologram engine arranged to:
receive a plurality of sub-holograms; and
form a hologram by spatially interlacing the sub-holograms, wherein the spatial interlacing is irregular such that at least one of (i) any patterns in a pixel arrangement of the hologram are irregular or (ii) any periodicity in the pixel arrangement of the hologram is greater than a dimension of the hologram.

2. The hologram engine of claim 1, wherein the hologram comprises a sequence of discrete portions of the sub-holograms randomly ordered by sub-hologram.

3. The hologram engine of claim 2, wherein the hologram engine is arranged such that the spatial interlacing comprises, for each discrete portion:
randomly selecting one of the plurality of sub-holograms; and
identifying a portion of the selected sub-hologram to form the discrete hologram portion.

4. The hologram engine of claim 1, wherein the hologram engine is arranged to (i) divide a first target picture into at least a first portion and a second portion, and (ii) calculate at least a first sub-hologram of the first portion of the first target picture and a second sub-hologram of the second portion of the first target picture.

5. The hologram engine of claim 4, wherein the first portion of the first target picture is a first field of view and the second portion of the first target picture is a second field of view.

6. The hologram engine of claim 4, wherein hologram engine is further arranged to divide the first target picture into a third portion and calculate a third sub-hologram of the third portion of the first target picture.

7. The hologram engine of claim 6, wherein the third portion of the first target picture is a third field of view.

8. The hologram engine of claim 4, wherein the hologram is a first hologram comprising a first sequence of discrete portions, and wherein the hologram engine is further arranged to form a second hologram comprising a second sequence of discrete portions of sub-holograms that is randomly ordered differently to the first sequence of discrete portions.

9. The hologram engine of claim 8, wherein the second hologram is formed based on a second target picture that is different to the first target picture.

10. The hologram engine of claim 9, wherein the hologram engine is arranged to (i) divide the second target picture into a plurality of portions, (ii) calculate a sub-hologram of each of the plurality of portions of the second target picture and (iii) form the second hologram by randomly spatially interlacing the sub-holograms of the second target picture such that the second hologram comprises a second sequence of second discrete portions of the sub-holograms randomly ordered by sub-hologram.

11. A holographic projection system comprising:
a hologram engine configured to (i) receive a plurality of sub-holograms, and (ii) form a hologram by spatially interlacing the sub-holograms, wherein the spatial interlacing is irregular such that at least one of (a) any patterns in a pixel arrangement of the hologram are irregular (b) any periodicity in the pixel arrangement of the hologram is greater than a dimension of the hologram; and
a holographic wavefront redirector positioned at or substantially adjacent to the hologram, or a relayed copy of the hologram, wherein the holographic wavefront redirector comprises a plurality of redirection zones, wherein a different subset of the plurality of redirection zones is optically coupled to each sub-hologram.

12. The holographic projection system of claim 11, wherein the plurality of redirection zones of the different subsets are arranged in correspondence with a pixel arrangement of the hologram such that pixels of each sub-hologram experience a same deflection angle.

13. The holographic projection system of claim 11, wherein each subset of the plurality of redirection zones is arranged to deflect received light at a different deflection angle with respect to a propagation axis to increase a field of view of the holographic projection system.

14. The holographic projection system of claim 13, wherein the holographic wavefront redirector comprises (i) a first subset of redirection zones optically coupled to a first sub-hologram of the hologram and (ii) a second subset of redirection zones optically coupled to a second sub-hologram of the hologram.

15. The holographic projection system of claim 14, wherein the holographic wavefront redirector comprises a third subset of redirection zones optically coupled to a third sub-hologram of the hologram.

16. The holographic projection system of claim 15, wherein each redirection zone of the first subset of redirection zones is arranged to deflect received light at a first deflection angle with respect to a propagation axis of the holographic projection system and each redirection zone of the second subset of redirection zones is arranged to deflect received light at a second deflection angle with respect to the propagation axis such that the holographic wavefront redirector is arranged to increase a field of view of the holographic projection system.

17. The holographic projection system of claim 15, wherein each third redirection zone of the third subset of redirection zones is arranged to deflect received light at a third deflection angle with respect to a propagation axis of the holographic projection system.

18. The holographic projection system of claim 11, wherein the holographic wavefront redirector is dynamic such that the plurality of redirection zones is reconfigurable in correspondence with the hologram formed by the hologram engine.

19. The holographic projection system of claim 18, wherein each of the plurality of redirection zones is reconfigurable to deflect received light at one of a plurality of discrete deflection angles.

20. The holographic projection system of claim 19, wherein the holographic projection system is arranged such that the holographic wavefront redirector is drivable between (i) a first configuration in which the redirection zones are arranged in correspondence with a first sequence of discrete portions of a first hologram formed by the hologram engine and (ii) a second configuration in which the redirection zones are arranged in correspondence with a second sequence of discrete portions of a second hologram.

21. A hologram of a target picture, the hologram comprising:
a plurality of sub-holograms, each sub-hologram being a sub-hologram of a portion of the target picture;
wherein the hologram is arranged such that the plurality of sub-holograms are randomly spatially interlaced such that the hologram comprises a sequence of discrete portions of the sub-holograms randomly ordered by sub-hologram.

22. A holographic wavefront redirector for a holographic projection system for spatially modulating light in accordance with a hologram to form a holographic wavefront, the hologram comprising a plurality of sub-holograms of a respective plurality of portions of a target picture, the plurality of sub-holograms being randomly spatially interlaced such that at least one of (i) any patterns in a pixel arrangement of the hologram are irregular or (ii) any periodicity in the pixel arrangement of the hologram is greater than a dimension of the hologram, and wherein the holographic wavefront redirector comprises:
a plurality of redirection zones comprising a plurality of subsets of redirection zones, each subset being optically coupled to a respective sub-hologram; and
wherein redirection zones of the subsets of redirection zones are arranged in correspondence with the pixel arrangement of the hologram such that pixels of each sub-hologram experience a same deflection angle.

23. A method of calculating a hologram, the method comprising:
dividing a target picture into a plurality of portions;
calculating a sub-hologram of each of the plurality of portions of the target picture; and
forming a hologram by randomly spatially interlacing the sub-holograms such that at least one of (i) any patterns in as pixel arrangement of the hologram are irregular or (ii) any periodicity in the pixel arrangement of the hologram is greater than a dimension of the hologram.

24. A method of increasing a field of view of a holographic projection system, the method comprising:
dividing a target picture into a plurality of portions;
calculating a sub-hologram of each portion of the target picture;
forming a hologram by randomly spatially interlacing the plurality of sub-holograms such that at least one of (i) any patterns in a pixel arrangement of the hologram are irregular or (ii) any periodicity in the pixel arrangement of the hologram is greater than a dimension of the hologram; and
receiving light at a plurality of redirection zones of a holographic wavefront redirector, wherein a different subset of the redirection zones is optically coupled to each sub-hologram, wherein each subset of redirection zones is arranged to deflect received light at a different deflection angle with respect to a propagation axis to increase a field of view of the holographic projection system.
